(19) United States
(12) Patent Application Publication
(10) Pub. No.: US 2022/0350113 A1
(43) Pub. Date: Nov. 3, 2022

(54) Optical Imaging Lens Assembly

(71) Applicant: ZHEJIANG SUNNY OPTICS CO.,LTD., Ningbo, Zhejiang (CN)

(72) Inventors: Jianke WENREN, Ningbo, Zhejiang (CN); Fujian DAI, Ningbo, Zhejiang (CN); Liefeng ZHAO, Ningbo, Zhejiang (CN)

(21) Appl. No.: 17/763,668

(22) PCT Filed: Jul. 24, 2020
(86) PCT No.: PCT/CN2020/104455

§ 371 Date: Mar. 25, 2022

(30) Foreign Application Priority Data
Sep. 25, 2019 (CN) 201910912301.4

(51) Int. Cl. G02B 9/64

(52) U.S. Cl. CPC G02B 9/64

(57) ABSTRACT

An optical imaging lens assembly sequentially includes, from an object side to an image side along an optical axis, a first lens (E1) with a positive refractive power, a second lens (E2) with a negative refractive power, a third lens (E3) with a refractive power, a fourth lens (E4) with a refractive power, a fifth lens (E5) with a refractive power, a sixth lens (E6) with a positive refractive power, and a seventh lens (E7) with a negative refractive power. EPD is an entrance pupil diameter of the optical imaging lens assembly, Semi-FOV is a half of a maximum field of view of the optical imaging lens assembly, and EPD and Semi-FOV satisfy: 11 mm<EPD/TAN(Semi-FOV)<20 mm. Therefore, a good shooting effect is achieved in a slightly dark environment.

### CROSS-REFERENCE TO RELATED APPLICATION(S)

The disclosure claims priority to and benefit of Chinese Patent Application No. 201910912301.4, filed to the China National Intellectual Property Administration (CNIPA) on Sep. 25, 2019, which is hereby incorporated by reference in its entirety.

### TECHNICAL FIELD

The disclosure relates to the field of optical elements, and particularly to an optical imaging lens assembly.

### BACKGROUND

With the constant development of camera equipment in recent years, the shooting quality of camera equipment has been continuously improved. Meanwhile, people have become more and more enthusiastic about photographing. Particularly, shooting in multiple scenes of different environments has become the common pursuit of people in photographing. In the face of continuous change of shooting environments, camera equipment capable of implementing long-distance high-resolution imaging in a slightly dark environment has become indispensable. However, an optical imaging lens assembly is the key to the shooting effect of camera equipment. Increasing an aperture of the optical imaging lens assembly is favorable for the camera equipment to achieve a good shooting effect in a slightly dark environment. Setting a telephoto characteristic of the optical imaging lens assembly is favorable for the long-distance high-resolution imaging of the camera equipment. The two aspects are combined to help to implement the long-distance high-resolution imaging of the camera equipment in the slightly dark environment.

### SUMMARY

An aspect of the disclosure provides an optical imaging lens assembly, which sequentially includes, from an object side to an image side along an optical axis: a first lens with a positive refractive power, a second lens with a negative refractive power, a third lens with a refractive power, a fourth lens with a refractive power, a fifth lens with a refractive power, a sixth lens with a positive refractive power, and a seventh lens with a negative refractive power.

In an implementation mode, EPD is an entrance pupil diameter of the optical imaging lens assembly, Semi-FOV is a half of a maximum field of view of the optical imaging lens assembly, and EPD and Semi-FOV satisfy: 11 mm<EPD/TAN(Semi-FOV)<20 mm.

In an implementation mode, EPD is an entrance pupil diameter of the optical imaging lens assembly, and a total effective focal length f of the optical imaging lens assembly and EPD satisfy: f/EPD<1.4.

In an implementation mode, TTL is a distance from an object-side surface of the first lens to an imaging surface of the optical imaging lens assembly on the optical axis, EPD is an entrance pupil diameter of the optical imaging lens assembly, and TTL and EPD satisfy: 1.2<TTL/EPD<1.6.

In an implementation mode, an effective focal length f1 of the first lens, an effective focal length f2 of the second lens, an effective focal length f6 of the sixth lens and an effective focal length f7 of the seventh lens satisfy: −1<(f2+f7)/(f1+f6)<−0.6.

In an implementation mode, a curvature radius R3 of an object-side surface of the second lens, a curvature radius R4 of an image-side surface of the second lens, a curvature radius R5 of an object-side surface of the third lens and a curvature radius R6 of an image-side surface of the third lens satisfy: 0.6<(R3+R4)/(R5+R6)<1.1.

In an implementation mode, a curvature radius R7 of an object-side surface of the fourth lens, a curvature radius R8 of an image-side surface of the fourth lens and an effective focal length f4 of the fourth lens satisfy: 0.1 mm<(R7×R8)/f4<0.6 mm.

In an implementation mode, a total effective focal length f of the optical imaging lens assembly satisfies: 7 mm<f<8 mm.

In an implementation mode, a spacing distance T34 between the third lens and the fourth lens on the optical axis, a spacing distance T45 between the fourth lens and the fifth lens on the optical axis, a spacing distance T56 between the fifth lens and the sixth lens on the optical axis and a spacing distance T67 between the sixth lens and the seventh lens on the optical axis satisfy: 0.6<(T34+T45)/(T56+T67)<1.0.

In an implementation mode, TTL is a distance from an object-side surface of the first lens to an imaging surface of the optical imaging lens assembly, and a center thickness CT1 of the first lens on the optical axis and TTL satisfy: 0.9<CT1/TTLx5<1.2.

In an implementation mode, SAG11 is an on-axis distance from an intersection point of an object-side surface of the first lens and the optical axis to an effective radius vertex of the object-side surface of the first lens, ImgH is a half of a diagonal length of an effective pixel region on an imaging surface of the optical imaging lens assembly, and SAG11 and ImgH satisfy: 0.3<SAG11/ImgH<0.6.

In an implementation mode, SAG31 is an on-axis distance from an intersection point of an object-side surface of the third lens and the optical axis to an effective radius vertex of the object-side surface of the third lens, SAG41 is an on-axis distance from an intersection point of an object-side surface of the fourth lens and the optical axis to an effective radius vertex of the object-side surface of the fourth lens, SAG71 is an on-axis distance from an intersection point of an object-side surface of the seventh lens and the optical axis to an effective radius vertex of the object-side surface of the seventh lens, and SAG31, SAG41 and SAG71 satisfy: 0.5<SAG31/(SAG41-SAG71)<0.9.

In an implementation mode, a combined focal length f123 of the first lens, the second lens and the third lens and a total effective focal length f of the optical imaging lens assembly satisfy: 1.0<f123/f<1.4.

In an implementation mode, an object-side surface of the first lens is a convex surface, an object-side surface of the sixth lens is a convex surface, and an image-side surface of the seventh lens is a concave surface.

The optical imaging lens assembly provided in the disclosure uses multiple lenses, e.g., the first lens to the seventh lens. An interrelationship of the entrance pupil diameter of the optical imaging lens assembly and a half of the maximum field of view of the optical imaging lens assembly is set reasonably, and the refractive power and surface types of the lenses are optimized, so that the lenses are matched reasonably to balance an aberration of the optical system, improve the imaging quality and endow the lens assembly with the characteristics of, for example, large aperture and great focal length.

### BRIEF DESCRIPTION OF THE DRAWINGS

Detailed descriptions are made to the following nonrestrictive implementation modes below in combination with the drawings to make the other features, objectives and advantages of the disclosure more apparent. In the drawings:

FIG. 1 shows a structure diagram of an optical imaging lens assembly according to Embodiment 1 of the disclosure;

FIGS. 2A-2D show a longitudinal aberration curve, an astigmatism curve, a distortion curve and a lateral color curve of an optical imaging lens assembly according to Embodiment 1 respectively;

FIG. 3 shows a structure diagram of an optical imaging lens assembly according to Embodiment 2 of the disclosure;

FIGS. 4A-4D show a longitudinal aberration curve, an astigmatism curve, a distortion curve and a lateral color curve of an optical imaging lens assembly according to Embodiment 2 respectively;

FIG. 5 shows a structure diagram of an optical imaging lens assembly according to Embodiment 3 of the disclosure;

FIGS. 6A-6D show a longitudinal aberration curve, an astigmatism curve, a distortion curve and a lateral color curve of an optical imaging lens assembly according to Embodiment 3 respectively;

FIG. 7 shows a structure diagram of an optical imaging lens assembly according to Embodiment 4 of the disclosure;

FIGS. 8A-8D show a longitudinal aberration curve, an astigmatism curve, a distortion curve and a lateral color curve of an optical imaging lens assembly according to Embodiment 4 respectively;

FIG. 9 shows a structure diagram of an optical imaging lens assembly according to Embodiment 5 of the disclosure;

FIGS. 10A-10D show a longitudinal aberration curve, an astigmatism curve, a distortion curve and a lateral color curve of an optical imaging lens assembly according to Embodiment 5 respectively;

FIG. 11 shows a structure diagram of an optical imaging lens assembly according to Embodiment 6 of the disclosure;

FIGS. 12A-12D show a longitudinal aberration curve, an astigmatism curve, a distortion curve and a lateral color curve of an optical imaging lens assembly according to Embodiment 6 respectively;

FIG. 13 shows a structure diagram of an optical imaging lens assembly according to Embodiment 7 of the disclosure;

FIGS. 14A-14D show a longitudinal aberration curve, an astigmatism curve, a distortion curve and a lateral color curve of an optical imaging lens assembly according to Embodiment 7 respectively.

FIG. 15 shows a structure diagram of an optical imaging lens assembly according to Embodiment 8 of the disclosure;

FIGS. 16A-16D show a longitudinal aberration curve, an astigmatism curve, a distortion curve and a lateral color curve of an optical imaging lens assembly according to Embodiment 8 respectively;

FIG. 17 shows a structure diagram of an optical imaging lens assembly according to Embodiment 9 of the disclosure;

FIGS. 18A-18D show a longitudinal aberration curve, an astigmatism curve, a distortion curve and a lateral color curve of an optical imaging lens assembly according to Embodiment 9 respectively;

FIG. 19 shows a structure diagram of an optical imaging lens assembly according to Embodiment 10 of the disclosure; and

FIGS. 20A-20D show a longitudinal aberration curve, astigmatism curve, distortion curve, and lateral color curve of an optical imaging lens assembly according to Embodiment 10 respectively.

### DETAILED DESCRIPTION OF THE EMBODIMENTS

In order to understand the disclosure better, more detailed descriptions will be made to each aspect of the disclosure with reference to the drawings. It is to be understood that these detailed descriptions are only descriptions about the exemplary implementation modes of the disclosure and not intended to limit the scope of the disclosure in any manner. In the whole specification, the same reference sign numbers represent the same components. Expression “and/or” includes any or all combinations of one or more in associated items that are listed.

It should be noted that, in this description, expressions first, second, third and the like are only used to distinguish one feature from another feature and do not represent any limitation to the feature. Thus, a first lens discussed below could also be referred to as a second lens or a third lens without departing from the teachings of the disclosure.

In the drawings, the thickness, size and shape of the lens have been slightly exaggerated for ease illustration. In particular, a spherical shape or aspheric shape shown in the drawings is shown by some embodiments. That is, the spherical shape or the aspheric shape is not limited to the spherical shape or aspheric shape shown in the drawings. The drawings are by way of example only and not strictly to scale.

Herein, a paraxial region refers to a region nearby an optical axis. If a lens surface is a convex surface and a position of the convex surface is not defined, it indicates that the lens surface is a convex surface at least in the paraxial region; and if a lens surface is a concave surface and a position of the concave surface is not defined, it indicates that the lens surface is a concave surface at least in the paraxial region. A surface, closest to a shot object, of each lens is called an object-side surface of the lens, and a surface, closest to an imaging surface, of each lens is called an image-side surface of the lens.

It should also be understood that terms “include”, “including”, “have”, “contain”, and/or “containing”, used in the specification, represent existence of a stated feature, component and/or part but do not exclude existence or addition of one or more other features, components and parts and/or combinations thereof. In addition, expressions like “at least one in . . . ” may appear after a list of listed characteristics not to modify an individual component in the list but to modify the listed characteristics. Moreover, when the implementation modes of the disclosure are described, “may” is used to represent “one or more implementation modes of the disclosure”. Furthermore, term “exemplary” refers to an example or exemplary description.

Unless otherwise defined, all terms (including technical terms and scientific terms) used in the disclosure have the same meanings as commonly understood by those of ordinary skill in the art of the disclosure. It should also be understood that the terms (for example, terms defined in a common dictionary) should be explained to have the same meanings as those in the context of a related art and may not be explained with ideal or excessively formal meanings, unless clearly defined like this in the disclosure.

It is to be noted that the embodiments in the disclosure and characteristics in the embodiments may be combined without conflicts. The disclosure will be described below with reference to the drawings and in combination with the embodiments in detail.

The features, principles and other aspects of the disclosure will be described below in detail.

An optical imaging lens assembly according to an exemplary implementation mode of the disclosure may include seven lenses with refractive power, i.e., a first lens, a second lens, a third lens, a fourth lens, a fifth lens, a sixth lens and a seventh lens. The seven lenses are sequentially arranged from an object side to an image side along an optical axis.

In an exemplary embodiment, the first lens may have a positive refractive power; the second lens may have a negative refractive power; the third lens may have a positive refractive power or a negative refractive power; the fourth lens may have a positive refractive power or a negative refractive power; the fifth lens may have a positive refractive power or a negative refractive power; the sixth lens may have a positive refractive power; and the seventh lens may have a negative refractive power. The first lens has a positive refractive power, and the second lens has a negative refractive power. The positive or negative refractive power of the first lens and the second lens is configured reasonably, so that a low-order aberration of the system may be balanced effectively, and the system is relatively high in imaging quality and machinability. The sixth lens has a positive refractive power, and the seventh lens has a negative refractive power, so that the reduction of a spherical aberration and astigmatism of the system and the improvement of the imaging quality of the optical system and a relative illumination of the optical system are facilitated.

In an exemplary embodiment, an object-side surface of the second lens may be a convex surface, while an image-side surface may be a concave surface.

In an exemplary embodiment, the third lens may have a positive refractive power, and an image-side surface thereof may be a concave surface.

In an exemplary embodiment, an object-side surface of the fourth lens may be a convex surface, while an image-side surface may be a concave surface.

In an exemplary embodiment, EPD is an entrance pupil diameter of the optical imaging lens assembly, Semi-FOV is a half of a maximum field of view of the optical imaging lens assembly, and EPD and Semi-FOV may satisfy: 11 mm<EPD/TAN(Semi-FOV)<20 mm, e.g., 11 mm<EPD/TAN(Semi-FOV)<15 mm. A ratio of the entrance pupil diameter of the optical imaging lens assembly to a half of the maximum field of view of the optical imaging lens assembly is set reasonably to help to ensure a relatively large aperture and relatively wide shooting range of the optical system.

In an exemplary embodiment, EPD is an entrance pupil diameter of the optical imaging lens assembly, and a total effective focal length f of the optical imaging lens assembly and EPD may satisfy: f/EPD<1.4, e.g., 1.2<f/EPD<1.4. The refractive power of the optical imaging lens assembly is configured reasonably, so that the F-number of the optical imaging lens assembly is smaller than 1.4, which contributes to achieving the characteristic of large aperture of the optical imaging lens assembly to make the optical imaging lens assembly more applicable to shooting environments with poor light such as cloudy days and the dusk to achieve high imaging quality.

In an exemplary embodiment, TTL is a distance from an object-side surface of the first lens to an imaging surface of the optical imaging lens assembly on the optical axis, EPD is an entrance pupil diameter of the optical imaging lens assembly, and TTL and EPD may satisfy: 1.2<TTL/EPD<1.6. A ratio of the distance from the object-side surface of the first lens to the imaging surface of the optical imaging lens assembly on the optical axis to the entrance pupil diameter of the optical imaging lens assembly is set reasonably to help to achieve an ultra-thin characteristic of the optical imaging lens assembly and endow the optical imaging lens with a relatively large relative aperture so as to achieve a relatively high light collecting capability.

In an exemplary embodiment, an effective focal length f1 of the first lens, an effective focal length f2 of the second lens, an effective focal length f6 of the sixth lens and an effective focal length f7 of the seventh lens may satisfy: −1<(f2+f7)/(f1+f6)<−0.6. Interrelationships between the effective focal lengths of the above lenses are set reasonably to help to control spherical aberration contributions of the four lenses within a reasonable level range so as to achieve high imaging quality in an on-axis field of view.

In an exemplary embodiment, a curvature radius R3 of an object-side surface of the second lens, a curvature radius R4 of an image-side surface of the second lens, a curvature radius R5 of an object-side surface of the third lens and a curvature radius R6 of an image-side surface of the third lens may satisfy: 0.6<(R3+R4)/(R5+R6)<1.1. A ratio of a sum of the curvature radii of the object-side surface and image-side surface of the second lens to a sum of the curvature radii of the object-side surface and image-side surface of the third lens is set reasonably to help to effectively control a deflection angle of rays entering the optical system after the rays pass through the second lens and the third lens, such that rays may be matched with a Chief Ray Angle (CRA) of a chip better when arriving at the imaging surface in each field of view of the optical system.

In an exemplary embodiment, a curvature radius R7 of an object-side surface of the fourth lens, a curvature radius R8 of an image-side surface of the fourth lens and an effective focal length f4 of the fourth lens may satisfy: 0.1 mm<(R7×R8)/f4<0.6 mm. A ratio of a product of the curvature radius of the object-side surface of the fourth lens and the curvature radius of the image-side surface of the fourth lens to the effective focal length of the fourth lens is set reasonably to help to control a curvature of the fourth lens effectively to make a field curvature contribution thereof within a reasonable range, so as to reduce the optical sensitivity of the fourth lens and further ensure high machinability of the fourth lens.

In an exemplary embodiment, a total effective focal length f of the optical imaging lens assembly may satisfy: 7 mm<f<8 mm. The total effective focal length f of the optical imaging lens assembly is set reasonably, so that the optical imaging lens assembly has a certain telephoto characteristic.

In an exemplary embodiment, a spacing distance T34 between the third lens and the fourth lens on the optical axis, a spacing distance T45 between the fourth lens and the fifth lens on the optical axis, a spacing distance T56 between the fifth lens and the sixth lens on the optical axis and a spacing distance T67 between the sixth lens and the seventh lens on the optical axis may satisfy: 0.6<(T34+T45)/(T56+T67)<1.0. Interrelationships between the spacing distances of the above adjacent lenses are set reasonably to help to control a space ratio of the above lenses in the optical system reasonably to ensure an assembling process of the lenses and help to miniaturize the optical imaging lens assembly.

In an exemplary embodiment, TTL is a distance from an object-side surface of the first lens to an imaging surface of the optical imaging lens assembly, and a center thickness CT1 of the first lens on the optical axis and TTL may satisfy: 0.9<CT1/TTLx5<1.2. A ratio of the center thickness of the first lens on the optical axis to the distance from the object-side surface of the first lens to the imaging surface of the optical imaging lens assembly on the optical axis is set reasonably to help to reduce the overall length of the optical system to make a front end of the optical imaging lens assembly relatively light and thin and help to reduce the machining sensitivity of the optical system.

In an exemplary embodiment, SAG11 is an on-axis distance from an intersection point of an object-side surface of the first lens and the optical axis to an effective radius vertex of the object-side surface of the first lens, ImgH is a half of a diagonal length of an effective pixel region on an imaging surface of the optical imaging lens assembly, and SAG11 and ImgH may satisfy: 0.3<SAG11/ImgH<0.6. A ratio of the on-axis distance from the intersection point of the object-side surface of the first lens and the optical axis to the effective radius vertex of the object-side surface of the first lens to a half of the diagonal length of the effective pixel region on the imaging surface of the optical imaging lens assembly is set reasonably to help to control a field curvature and distortion of the optical imaging lens assembly effectively and improve the imaging quality thereof.

In an exemplary embodiment, SAG31 is an on-axis distance from an intersection point of an object-side surface of the third lens and the optical axis to an effective radius vertex of the object-side surface of the third lens, SAG41 is an on-axis distance from an intersection point of an object-side surface of the fourth lens and the optical axis to an effective radius vertex of the object-side surface of the fourth lens, SAG71 is an on-axis distance from an intersection point of an object-side surface of the seventh lens and the optical axis to an effective radius vertex of the object-side surface of the seventh lens, and SAG31, SAG41 and SAG71 may satisfy: 0.5<SAG31/(SAG41-SAG71)<0.9. Interrelationships between the three distances are set reasonably to help to balance a field curvature, a longitudinal spherical aberration and a spherochromatic aberration of the optical imaging lens assembly better to further achieve high imaging quality and relatively low system sensitivity of the optical imaging lens assembly, thereby ensuring high machinability of the optical imaging lens assembly.

In an exemplary embodiment, a combined focal length f123 of the first lens, the second lens and the third lens and a total effective focal length f of the optical imaging lens assembly may satisfy: 1.0<f123/f<1.4. A ratio of the combined focal length of the first lens, the second lens and the third lens to the total effective focal length of the optical imaging lens assembly is set reasonably to help to reduce a deflection angle of rays in the optical system and the sensitivity of the optical system.

In an exemplary embodiment, an object-side surface of the first lens may be a convex surface, an object-side surface of the sixth lens may be a convex surface, and an image-side surface of the seventh lens may be a concave surface. Surface types of the object-side surface of the first lens, the object-side surface of the sixth lens and the image-side surface of the seventh lens are set reasonably to help to reduce an incidence angle of rays at a diaphragm and reduce a pupil aberration, so as to improve the imaging quality and help to improve the relative illumination of the optical system.

In an exemplary embodiment, the optical imaging lens assembly may further include a diaphragm. The diaphragm may be arranged at a proper position as required. For example, the diaphragm may be arranged between the object side and the first lens. Optionally, the optical imaging lens assembly may further include an optical filter configured to correct the chromatic aberration and/or protective glass configured to protect a photosensitive element on the imaging surface.

The optical imaging lens assembly according to the disclosure uses seven aspheric lenses. Different lenses may be matched and designed to achieve relatively high imaging quality. In addition, according to the optical imaging lens assembly of the disclosure, the refractive power is configured reasonably, and high-order aspheric parameters are optimized and selected, so that the optical system is endowed with high imaging quality, a large aperture and a certain telephoto characteristic.

In an exemplary embodiment, at least one of mirror surfaces of each lens is an aspheric mirror surface. That is, at least one mirror surface in the object-side surface of the first lens to the image-side surface of the seventh lens is an aspheric mirror surface. An aspheric lens has a characteristic that a curvature keeps changing from a center of the lens to a periphery of the lens. Unlike a spherical lens with a constant curvature from a center of the lens to a periphery of the lens, the aspheric lens has a better curvature radius characteristic and the advantages of improving distortions and improving astigmatic aberrations. With the adoption of the aspheric lens, astigmatic aberrations during imaging may be eliminated as much as possible, thereby improving the imaging quality. Optionally, at least one of the object-side surface and image-side surface of each lens in the first lens, the second lens, the third lens, the fourth lens, the fifth lens, the sixth lens and the seventh lens is an aspheric mirror surface. Optionally, both the object-side surface and image-side surface of each lens in the first lens, the second lens, the third lens, the fourth lens, the fifth lens, the sixth lens and the seventh lens are aspheric mirror surfaces.

The disclosure also provides an imaging device, which may use a Charge-Coupled Device (CCD) or a Complementary Metal Oxide Semiconductor (CMOS) as an electronic photosensitive element. The imaging device may be an independent imaging device such as a digital camera, or may be an imaging module integrated into a mobile electronic device such as a mobile phone. The imaging device is provided with the above-mentioned optical imaging lens assembly.

The exemplary implementation mode of the disclosure also provides an electronic device, which includes the above-mentioned imaging device.

However, those skilled in the art should know that the number of the lenses forming the optical imaging lens assembly may be changed without departing from the technical solutions claimed in the disclosure to achieve each result and advantage described in the specification. For example, although descriptions are made in the implementation with seven lenses as an example, the optical imaging lens assembly is not limited to seven lenses. If necessary, the optical imaging lens assembly may also include another number of lenses.

Specific embodiments applicable to the optical imaging lens assembly of the above-mentioned implementation mode will further be described below with reference to the drawings.

### Embodiment 1

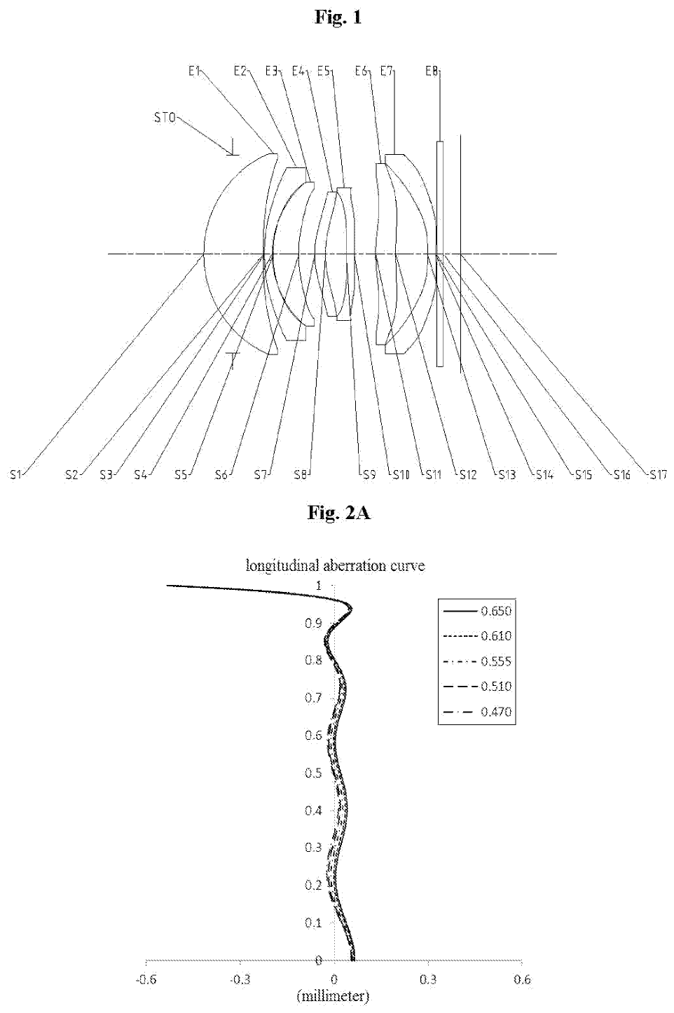

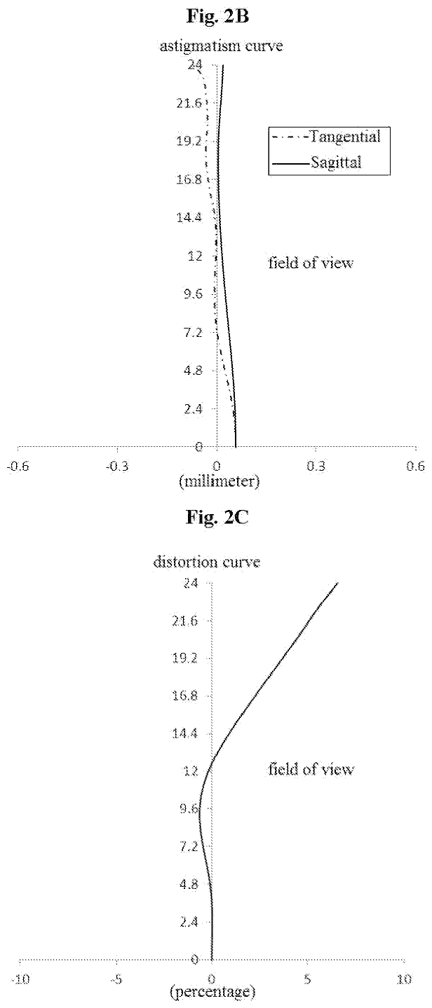

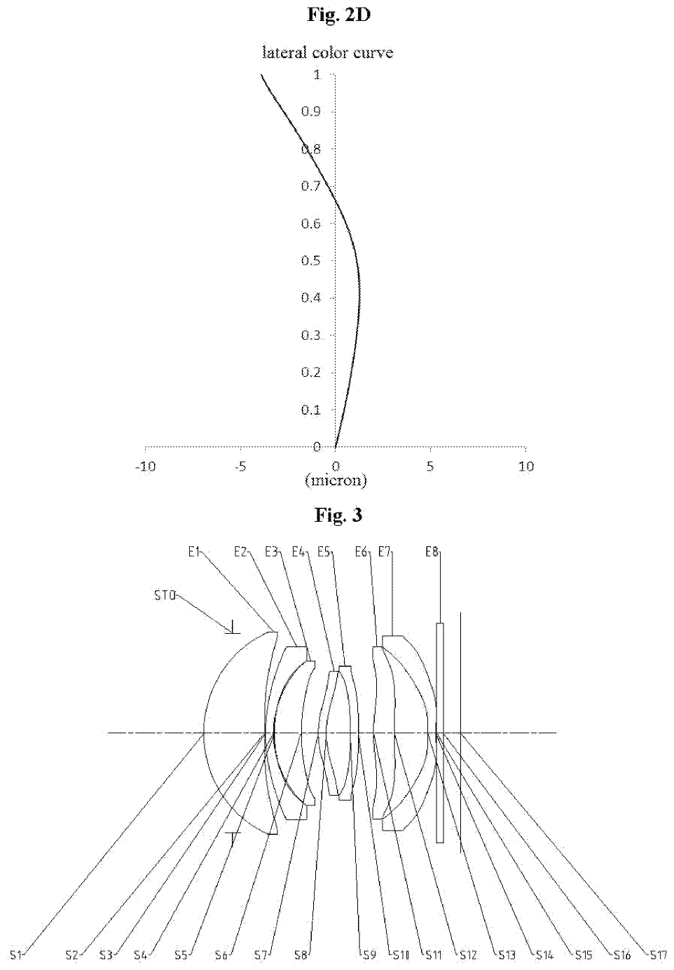

An optical imaging lens assembly according to Embodiment 1 of the disclosure will be described below with reference to FIGS. 1-2D. FIG. 1 is a structure diagram of an optical imaging lens assembly according to Embodiment 1 of the disclosure.

As shown in FIG. 1, the optical imaging lens assembly sequentially includes, from an object side to an image side along an optical axis, a diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, while an image-side surface S2 is a concave surface. The second lens E2 has a negative refractive power, an object-side surface S3 thereof is a convex surface, while an image-side surface S4 is a concave surface. The third lens E3 has a positive refractive power, an object-side surface S5 thereof is a convex surface, while an image-side surface S6 is a concave surface. The fourth lens E4 has a positive refractive power, an object-side surface S7 thereof is a convex surface, while an image-side surface S8 is a concave surface. The fifth lens E5 has a negative refractive power, an object-side surface S9 thereof is a convex surface, while an image-side surface S10 is a concave surface. The sixth lens E6 has a positive refractive power, an object-side surface S11 thereof is a convex surface, while an image-side surface S12 is a concave surface. The seventh lens E7 has a negative refractive power, an object-side surface S13 thereof is a concave surface, while an image-side surface S14 is a concave surface. The optical filter E8 has an object-side surface S15 and an image-side surface S16. Light from an object sequentially penetrates through each of the surfaces S1 to S16, and is finally imaged on the imaging surface S17.

Table 1 shows a table of basic parameters for the optical imaging lens assembly of Embodiment 1, and units of the curvature radius, the thickness/distance and the focal length are all millimeter (mml.

TABLE 1

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | Infinite | | | | |
| STO | Spherical | Infinite | −0.9000 | | | | |
| S1 | Aspheric | 3.0583 | 1.8600 | 1.54 | 55.7 | 6.64 | 0.0000 |
| S2 | Aspheric | 16.9651 | 0.0300 | | | | 0.0000 |
| S3 | Aspheric | 3.9934 | 0.2500 | 1.68 | 19.2 | −8.22 | 0.0000 |
| S4 | Aspheric | 2.2669 | 0.0300 | | | | 0.0000 |
| S5 | Aspheric | 2.6993 | 0.7940 | 1.54 | 55.7 | 20.45 | 0.0000 |
| S6 | Aspheric | 3.2118 | 0.5049 | | | | 0.0000 |
| S7 | Aspheric | 2.3923 | 0.3348 | 1.54 | 55.7 | 23.78 | 0.0000 |
| S8 | Aspheric | 2.8001 | 0.6546 | | | | 0.0000 |
| S9 | Aspheric | 21.3232 | 0.2500 | 1.65 | 23.5 | −32.97 | 0.0000 |
| S10 | Aspheric | 10.5854 | 0.6690 | | | | 0.0000 |
| S11 | Aspheric | 4.9235 | 0.6260 | 1.68 | 19.2 | 11.72 | 0.0000 |
| S12 | Aspheric | 12.2936 | 0.9949 | | | | 0.0000 |
| S13 | Aspheric | −10.1557 | 0.2518 | 1.54 | 55.7 | −6.35 | 0.0000 |
| S14 | Aspheric | 5.1681 | 0.0300 | | | | 0.0000 |
| S15 | Spherical | Infinite | 0.2100 | 1.52 | 64.2 | | |
| S16 | Spherical | Infinite | 0.5400 | | | | |
| S17 | Spherical | Infinite | | | | | |

In the embodiment, a total effective focal length f of the optical imaging lens is 7.46 mm. TTL is a distance from the object-side surface S1 of the first lens E1 to the imaging surface S17 on the optical axis, and TTL is 8.03 mm. ImgH is a half of a diagonal length of an effective pixel region on the imaging surface S17, and ImgH is 3.49 mm.

In Embodiment 1, both the object-side surface and image-side surface of any lens in the first lens E1 to the seventh lens E7 are aspheric surfaces. A surface type x of each aspheric lens may be defined through, but not limited to, the following aspheric surface formula:

$$x = \frac{{ch}^{2}}{1 + \sqrt{1 - ( k + 1 ) {c}^{2} {h}^{2}}} + \sum {Aih}^{i} , \qquad ( 1 )$$

wherein x is a distance vector height from a vertex of the aspheric surface when the aspheric surface is at a height of h along the optical axis direction; c is a paraxial curvature of the aspheric surface, c=1/R (namely, the paraxial curvature c is a reciprocal of the curvature radius R in Table 1); k is a conic coefficient; and Ai is a correction coefficient of the i-th order of the aspheric surface. Table 2 shows higher-order coefficients A₄, A₆, A₁₀, A₁₀, A₁₂, A₁₄ and A₁₆ that can be used for each of the aspheric mirror surfaces S1-S14 in Embodiment 1.

TABLE 2

| Surface | | | | | | | |
|---|---|---|---|---|---|---|---|
| number | A4 | A6 | A8 | A10 | A12 | A14 | A16 |
| S1 | −2.6000E−04 | −2.5000E−04 | −1.5000E−05 | 4.0400E−05 | −1.3000E−05 | 1.6200E−06 | −7.6177E−08 |
| S2 | −3.9000E−05 | 7.5380E−03 | −3.5600E−03 | 7.9500E−04 | −9.5000E−05 | 5.7900E−06 | −1.4173E−07 |
| S3 | −1.5780E−02 | 8.8770E−03 | −2.5200E−03 | 1.0700E−04 | 6.8300E−05 | −1.1000E−05 | 5.3573E−07 |
| S4 | −6.7440E−02 | 7.9630E−02 | −5.6480E−02 | 2.3148E−02 | −5.6800E−03 | 7.7100E−04 | −4.4614E−05 |
| S5 | −6.5530E−02 | 8.2803E−02 | −5.0300E−02 | 1.6373E−02 | −2.8800E−03 | 2.5800E−04 | −8.7965E−06 |
| S6 | −3.9640E−02 | 2.4752E−02 | −1.7720E−02 | 8.5570E−03 | −2.4400E−03 | 3.9300E−04 | −2.6821E−05 |
| S7 | −4.1500E−02 | 3.4680E−03 | −2.4000E−04 | −3.2800E−03 | 2.0540E−03 | −4.6000E−04 | 3.6109E−05 |
| S8 | −2.6750E−02 | 5.4820E−03 | −3.4000E−03 | −1.5300E−03 | 1.5720E−03 | −4.2000E−04 | 3.7760E−05 |
| S9 | −6.8610E−02 | 2.8996E−02 | −8.8300E−03 | 1.5160E−03 | −1.8000E−04 | 2.0000E−05 | −4.0298E−06 |
| S10 | −8.3870E−02 | 4.2621E−02 | −1.9890E−02 | 8.1850E−03 | −2.3300E−03 | 3.9100E−04 | −2.8016E−05 |
| S11 | −2.5960E−02 | −9.2000E−04 | 4.0200E−04 | −9.0000E−05 | 4.8700E−05 | −8.4000E−06 | 4.4138E−07 |
| S12 | −1.0230E−02 | −3.8800E−03 | 6.7900E−04 | 2.5400E−06 | −5.3000E−06 | 1.0100E−07 | 1.2960E−08 |
| S13 | −1.6013E−01 | 9.6599E−02 | −3.6890E−02 | 9.2080E−03 | −1.4100E−03 | 1.1800E−04 | −4.0854E−06 |
| S14 | −1.7514E−01 | 7.9941E−02 | −2.2450E−02 | 4.0350E−03 | −4.5000E−04 | 2.8000E−05 | −7.2573E−07 |

FIG. 2A shows a longitudinal aberration curve of the optical imaging lens assembly according to Embodiment 1 to represent deviations of a convergence focal point after light with different wavelengths passes through the lens assembly. FIG. 2B shows an astigmatism curve of the optical imaging lens assembly according to Embodiment 1 to represent a tangential image surface curvature and a sagittal image surface curvature. FIG. 2C shows a distortion curve of the optical imaging lens assembly according to Embodiment 1 to represent distortion values corresponding to different fields of view. FIG. 2D shows a lateral color curve of the optical imaging lens assembly according to Embodiment 1 to represent deviations of different image heights on the imaging surface after the light passes through the lens assembly. According to FIGS. 2A-2D, it can be seen that the optical imaging lens assembly provided in Embodiment 1 may achieve high imaging quality.

### Embodiment 2

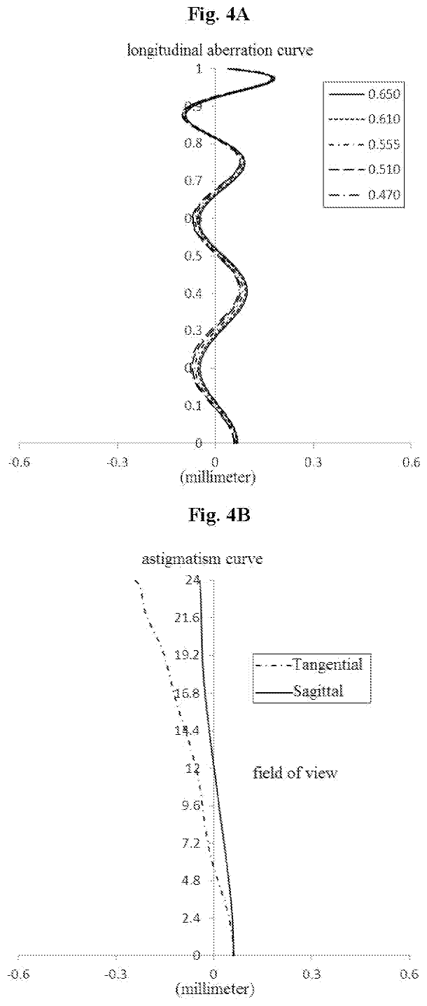

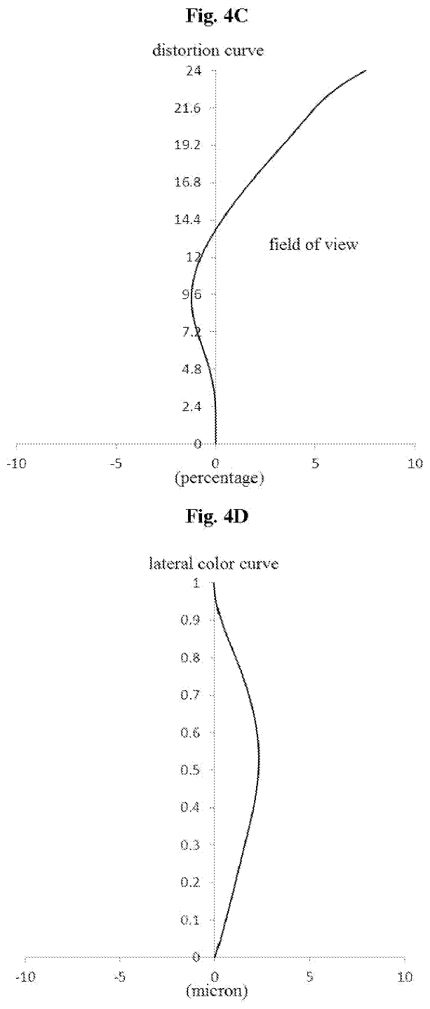

An optical imaging lens assembly according to Embodiment 2 of the disclosure will be described below with reference to FIGS. 3-4D. FIG. 3 is a structure diagram of an optical imaging lens assembly according to Embodiment 2 of the disclosure.

As shown in FIG. 3, the optical imaging lens assembly sequentially includes, from an object side to an image side along an optical axis, a diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, while an image-side surface S2 is a concave surface. The second lens E2 has a negative refractive power, an object-side surface S3 thereof is a convex surface, while an image-side surface S4 is a concave surface. The third lens E3 has a positive refractive power, an object-side surface S5 thereof is a convex surface, while an image-side surface S6 is a concave surface. The fourth lens E4 has a positive refractive power, an object-side surface S7 thereof is a convex surface, while an image-side surface S8 is a concave surface. The fifth lens E5 has a negative refractive power, an object-side surface S9 thereof is a concave surface, while an image-side surface S10 is a concave surface. The sixth lens E6 has a positive refractive power, an object-side surface S11 thereof is a convex surface, while an image-side surface S12 is a concave surface. The seventh lens E7 has a negative refractive power, an object-side surface S13 thereof is a concave surface, while an image-side surface S14 is a concave surface. The optical filter E8 has an object-side surface S15 and an image-side surface S16. Light from an object sequentially penetrates through each of the surfaces S1 to S16, and is finally imaged on the imaging surface S17.

In the embodiment, a total effective focal length f of the optical imaging lens is 7.48 mm. TTL is a distance from the object-side surface S1 of the first lens E1 to the imaging surface S17 on the optical axis, and TTL is 8.03 mm. ImgH is a half of a diagonal length of an effective pixel region on the imaging surface S17, and ImgH is 3.52 mm.

Table 3 shows a table of basic parameters for the optical imaging lens assembly of Embodiment 2, and units of the curvature radius, the thickness/distance and the focal length are all millimeter (mm).

TABLE 3

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | Infinite | | | | |
| STO | Spherical | Infinite | −0.9000 | | | | |
| S1 | Aspheric | 3.0721 | 1.8945 | 1.54 | 55.7 | 6.34 | 0.0000 |
| S2 | Aspheric | 24.7876 | 0.0300 | | | | 0.0000 |
| S3 | Aspheric | 3.8736 | 0.2500 | 1.68 | 19.2 | −8.11 | 0.0000 |
| S4 | Aspheric | 2.2123 | 0.0300 | | | | 0.0000 |
| S5 | Aspheric | 3.0164 | 0.8372 | 1.54 | 55.7 | 18.58 | 0.0000 |
| S6 | Aspheric | 3.9055 | 0.5341 | | | | 0.0000 |
| S7 | Aspheric | 2.1179 | 0.2514 | 1.54 | 55.7 | 35.46 | 0.0000 |
| S8 | Aspheric | 2.2843 | 0.7479 | | | | 0.0000 |
| S9 | Aspheric | −20.3457 | 0.2500 | 1.65 | 23.5 | −19.00 | 0.0000 |
| S10 | Aspheric | 30.8025 | 0.4792 | | | | 0.0000 |
| S11 | Aspheric | 4.3028 | 0.6521 | 1.68 | 19.2 | 9.06 | 0.0000 |
| S12 | Aspheric | 13.5014 | 1.0436 | | | | 0.0000 |
| S13 | Aspheric | −13.4015 | 0.2500 | 1.54 | 55.7 | −5.67 | 0.0000 |
| S14 | Aspheric | 3.9633 | 0.0300 | | | | 0.0000 |
| S15 | Spherical | Infinite | 0.2100 | 1.52 | 64.2 | | |
| S16 | Spherical | Infinite | 0.5400 | | | | |
| S17 | Spherical | Infinite | | | | | |

In Embodiment 2, both the object-side surface and image-side surface of any lens in the first lens E1 to the seventh lens E7 are aspheric surfaces. Table 4 shows higher-order coefficients A₄, A₆, A₈, A₁₀, A₁₂, A₁₄ and A₁₆ that can be used for each of the aspheric mirror surfaces S1-S14 in Embodiment 2.

TABLE 4

| Surface | | | | | | | |
|---|---|---|---|---|---|---|---|
| number | A4 | A6 | A8 | A10 | A12 | A14 | A16 |
| S1 | −2.6000E−04 | −3.6000E−04 | 5.7100E−05 | 1.9800E−05 | −9.3000E−06 | 1.2639E−06 | −6.1545E−08 |
| S2 | −1.1100E−03 | 8.9160E−03 | −3.4900E−03 | 6.1500E−04 | −5.4000E−05 | 2.1279E−06 | −2.1329E−08 |
| S3 | −2.4060E−02 | 7.8060E−03 | 4.5600E−04 | −1.1000E−03 | 2.9000E−04 | −3.1001E−05 | 1.2131E−06 |
| S4 | −9.0700E−02 | 1.1811E−01 | −9.9120E−02 | 4.9055E−02 | −1.4100E−02 | 2.1475E−03 | −1.3395E−04 |
| S5 | −6.5990E−02 | 8.8794E−02 | −5.0070E−02 | 1.5067E−02 | −2.4700E−03 | 2.0787E−04 | −6.8941E−06 |
| S6 | −4.0090E−02 | 3.3095E−02 | −2.3060E−02 | 1.0654E−02 | −2.9600E−03 | 4.6411E−04 | −3.0987E−05 |
| S7 | −6.9710E−02 | 1.4507E−02 | −1.3830E−02 | 5.6050E−03 | −1.0200E−03 | 1.0583E−04 | −8.5102E−06 |
| S8 | −5.1630E−02 | 1.3709E−02 | −1.5610E−02 | 7.3890E−03 | −1.7600E−03 | 2.2961E−04 | −1.4732E−05 |
| S9 | −6.5190E−02 | 4.8207E−02 | −2.6460E−02 | 1.1130E−02 | −3.7600E−03 | 7.7160E−04 | −6.7443E−05 |
| S10 | −9.8710E−02 | 6.8187E−02 | −3.6760E−02 | 1.5113E−02 | −4.3700E−03 | 7.5186E−04 | −5.4352E−05 |
| S11 | −4.6540E−02 | 4.7100E−03 | 2.0720E−03 | −1.6700E−03 | 4.5900E−04 | −5.4213E−05 | 2.3398E−06 |
| S12 | −2.0720E−02 | −3.0100E−03 | 2.9410E−03 | −1.0500E−03 | 1.8600E−04 | −1.5142E−05 | 4.5380E−07 |
| S13 | −2.2795E−01 | 1.3792E−01 | −4.8710E−02 | 1.0982E−02 | −1.5700E−03 | 1.2546E−04 | −4.1647E−06 |
| S14 | −2.4797E−01 | 1.2406E−01 | −3.6570E−02 | 6.6980E−03 | −7.6000E−04 | 4.7629E−05 | −1.2647E−06 |

FIG. 4A shows a longitudinal aberration curve of the optical imaging lens assembly according to Embodiment 2 to represent deviations of a convergence focal point after light with different wavelengths passes through the lens assembly. FIG. 4B shows an astigmatism curve of the optical imaging lens assembly according to Embodiment 2 to represent a tangential image surface curvature and a sagittal image surface curvature. FIG. 4C shows a distortion curve of the optical imaging lens assembly according to Embodiment 2 to represent distortion values corresponding to different fields of view. FIG. 4D shows a lateral color curve of the optical imaging lens assembly according to Embodiment 2 to represent deviations of different image heights on the imaging surface after the light passes through the lens assembly. According to FIGS. 4A-4D, it can be seen that the optical imaging lens assembly provided in Embodiment 2 may achieve high imaging quality.

### Embodiment 3

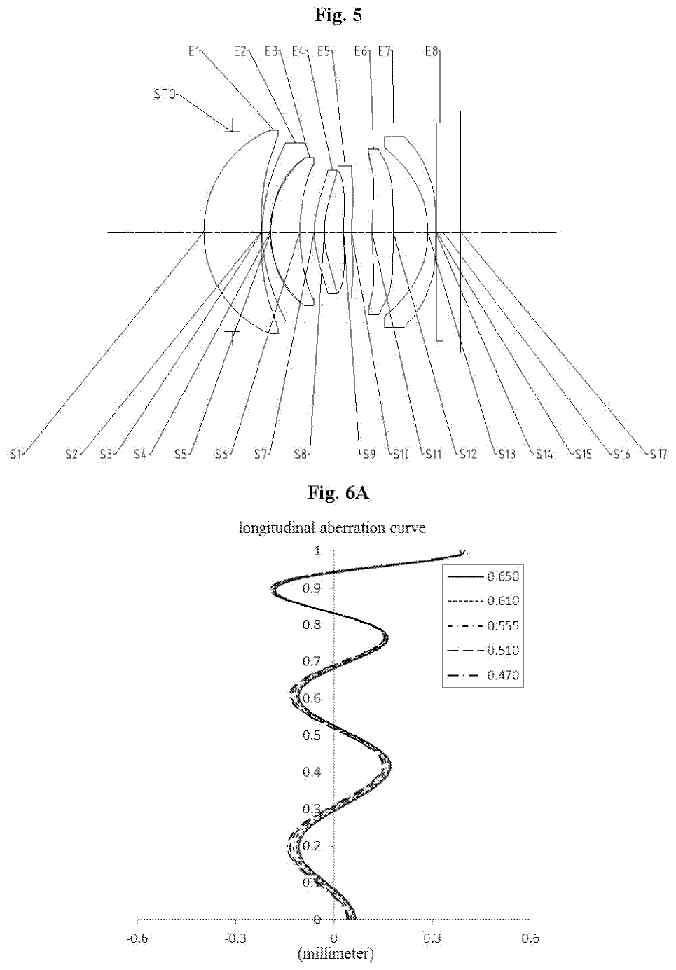

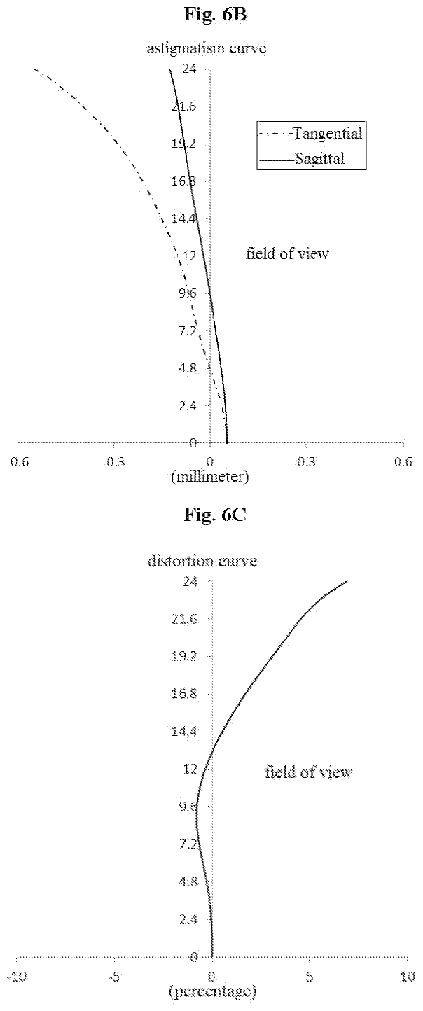

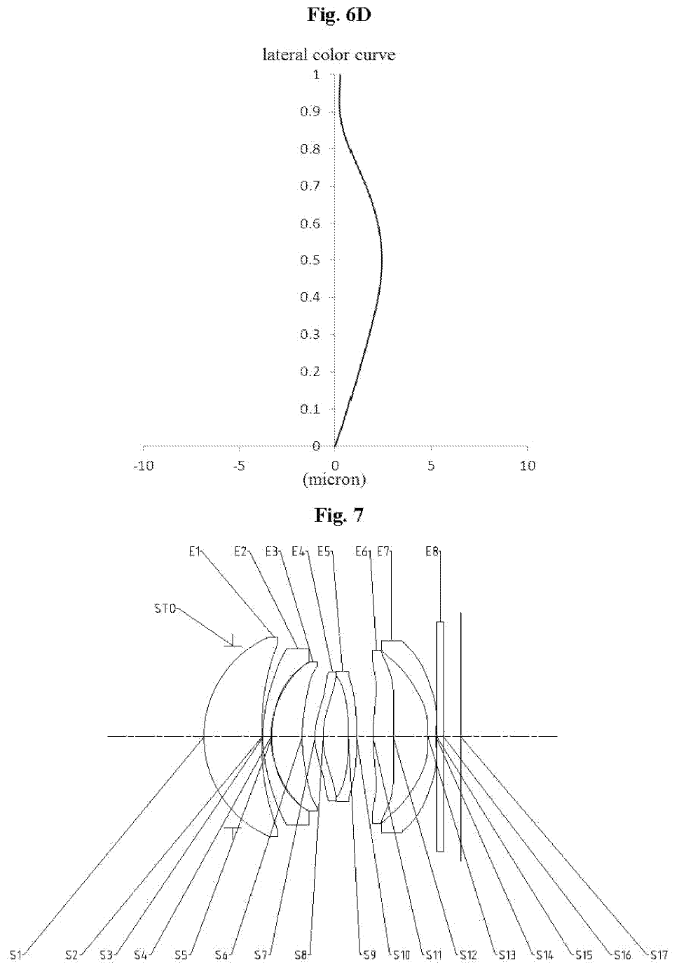

An optical imaging lens assembly according to Embodiment 3 of the disclosure will be described below with reference to FIGS. 5-6D. FIG. 5 is a structure diagram of an optical imaging lens assembly according to Embodiment 3 of the disclosure.

As shown in FIG. 5, the optical imaging lens assembly sequentially includes, from an object side to an image side along an optical axis, a diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, while an image-side surface S2 is a concave surface. The second lens E2 has a negative refractive power, an object-side surface S3 thereof is a convex surface, while an image-side surface S4 is a concave surface. The third lens E3 has a positive refractive power, an object-side surface S5 thereof is a convex surface, while an image-side surface S6 is a concave surface. The fourth lens E4 has a positive refractive power, an object-side surface S7 thereof is a convex surface, while an image-side surface S8 is a concave surface. The fifth lens E5 has a negative refractive power, an object-side surface S9 thereof is a convex surface, while an image-side surface S10 is a concave surface. The sixth lens E6 has a positive refractive power, an object-side surface S11 thereof is a convex surface, while an image-side surface S12 is a convex surface. The seventh lens E7 has a negative refractive power, an object-side surface S13 thereof is a concave surface, while an image-side surface S14 is a concave surface. The optical filter E8 has an object-side surface S15 and an image-side surface S16. Light from an object sequentially penetrates through each of the surfaces S1 to S16, and is finally imaged on the imaging surface S17.

In the embodiment, a total effective focal length f of the optical imaging lens is 7.46 mm. TTL is a distance from the object-side surface S1 of the first lens E1 to the imaging surface S17 on the optical axis, and TTL is 8.03 mm. ImgH is a half of a diagonal length of an effective pixel region on the imaging surface S17, and ImgH is 3.50 mm.

Table 5 shows a table of basic parameters for the optical imaging lens assembly of Embodiment 3, and units of the curvature radius, the thickness/distance and the focal length are all millimeter (mm).

TABLE 5

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | Infinite | | | | |
| STO | Spherical | Infinite | −0.9000 | | | | |
| S1 | Aspheric | 3.0590 | 1.7903 | 1.54 | 55.7 | 7.12 | 0.0000 |
| S2 | Aspheric | 12.1847 | 0.0300 | | | | 0.0000 |
| S3 | Aspheric | 3.6387 | 0.2500 | 1.68 | 19.2 | −9.27 | 0.0000 |
| S4 | Aspheric | 2.2403 | 0.0300 | | | | 0.0000 |
| S5 | Aspheric | 3.0060 | 0.9002 | 1.54 | 55.7 | 18.27 | 0.0000 |
| S6 | Aspheric | 3.8817 | 0.4565 | | | | 0.0000 |
| S7 | Aspheric | 2.3245 | 0.3136 | 1.54 | 55.7 | 25.75 | 0.0000 |
| S8 | Aspheric | 2.6630 | 0.6000 | | | | 0.0000 |
| S9 | Aspheric | 8.0042 | 0.2500 | 1.65 | 23.5 | −25.90 | 0.0000 |
| S10 | Aspheric | 5.3412 | 0.6395 | | | | 0.0000 |
| S11 | Aspheric | 7.2948 | 0.6626 | 1.68 | 19.2 | 9.81 | 0.0000 |
| S12 | Aspheric | −72.0424 | 1.0773 | | | | 0.0000 |
| S13 | Aspheric | −4.8773 | 0.2500 | 1.54 | 55.7 | −5.61 | 0.0000 |
| S14 | Aspheric | 8.0171 | 0.0300 | | | | 0.0000 |
| S15 | Spherical | Infinite | 0.2100 | 1.52 | 64.2 | | |
| S16 | Spherical | Infinite | 0.5400 | | | | |
| S17 | Spherical | Infinite | | | | | |

In Embodiment 3, both the object-side surface and image-side surface of any lens in the first lens E1 to the seventh lens E7 are aspheric surfaces. Table 6 shows higher-order coefficients A₄, A₆, A₈, A₁₀, A₁₂, A₁₄ and A₁₆ that can be used for each of the aspheric mirror surfaces S1-S14 in Embodiment 3.

TABLE 6

| Surface | | | | | | | |
|---|---|---|---|---|---|---|---|
| number | A4 | A6 | A8 | A10 | A12 | A14 | A16 |
| S1 | −3.9000E−04 | −4.0000E−05 | −1.5000E−04 | 8.1700E−05 | −1.9000E−05 | 2.1213E−06 | −9.1971E−08 |
| S2 | 7.2900E−04 | 4.4090E−03 | −1.6700E−03 | 3.0500E−04 | −3.1000E−05 | 1.5756E−06 | −3.0434E−08 |
| S3 | −2.0580E−02 | 6.0090E−03 | −6.0000E−04 | −2.8000E−04 | 9.0900E−05 | −1.0060E−05 | 3.9123E−07 |
| S4 | −6.7860E−02 | 1.0779E−01 | −1.1084E−01 | 6.0965E−02 | −1.8170E−02 | 2.7606E−03 | −1.6797E−04 |
| S5 | −2.1860E−02 | 2.3021E−02 | −8.6900E−03 | 1.3490E−03 | 4.9700E−05 | −3.5794E−05 | 2.8678E−06 |
| S6 | −2.9660E−02 | 1.5281E−02 | −8.0300E−03 | 3.0360E−03 | −6.6000E−04 | 8.3154E−05 | −4.7256E−06 |
| S7 | 4.0580E−02 | 2.6680E−03 | 1.6200E−05 | −3.4900E−03 | 2.2220E−03 | −5.2257E−04 | 4.4298E−05 |
| S8 | −2.4910E−02 | 4.1080E−03 | −2.7000E−03 | −2.1200E−03 | 1.8930E−03 | −4.9762E−04 | 4.4533E−05 |
| S9 | −5.9930E−02 | 1.0730E−02 | 9.1460E−03 | −9.5500E−03 | 3.6090E−03 | −6.1972E−04 | 3.5366E−05 |
| S10 | −7.0560E−02 | 2.0385E−02 | −7.9000E−04 | −2.9600E−03 | 1.4490E−03 | −2.7117E−04 | 1.8312E−05 |
| S11 | −1.1440E−02 | −8.7400E−03 | 6.0280E−03 | −3.2000E−03 | 9.0400E−04 | −1.1735E−04 | 5.6690E−06 |
| S12 | −1.9000E−03 | −4.1600E−03 | 1.3560E−03 | −7.5000E−04 | 1.9900E−04 | −2.1916E−05 | 8.6269E−07 |
| S13 | −1.3925E−01 | 9.5947E−02 | −3.8360E−02 | 9.3550E−03 | −1.3900E−03 | 1.1429E−04 | −3.8865E−06 |
| S14 | −1.6101E−01 | 8.5207E−02 | −2.7740E−02 | 5.5810E−03 | −6.8000E−04 | 4.5171E−05 | −1.2495E−06 |

FIG. 6A shows a longitudinal aberration curve of the optical imaging lens assembly according to Embodiment 3 to represent deviations of a convergence focal point after light with different wavelengths passes through the lens assembly. FIG. 6B shows an astigmatism curve of the optical imaging lens assembly according to Embodiment 3 to represent a tangential image surface curvature and a sagittal image surface curvature. FIG. 6C shows a distortion curve of the optical imaging lens assembly according to Embodiment 3 to represent distortion values corresponding to different fields of view. FIG. 6D shows a lateral color curve of the optical imaging lens assembly according to Embodiment 3 to represent deviations of different image heights on the imaging surface after the light passes through the lens assembly. According to FIGS. 6A-6D, it can be seen that the optical imaging lens assembly provided in Embodiment 3 may achieve high imaging quality.

### Embodiment 4

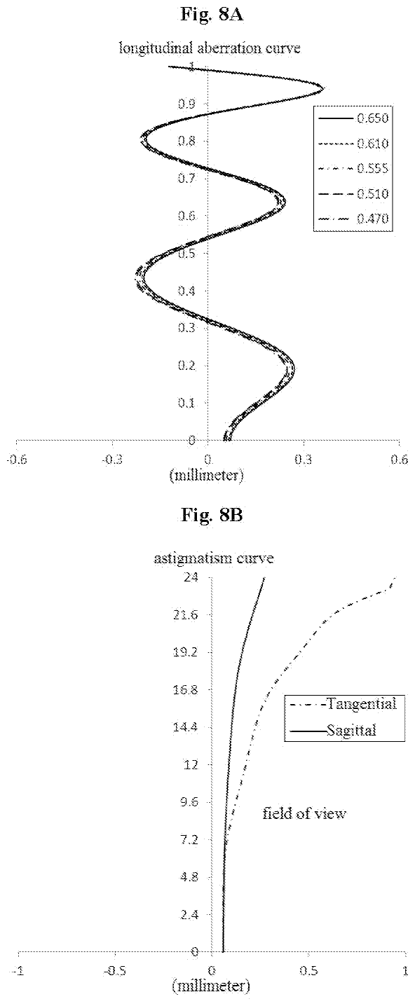

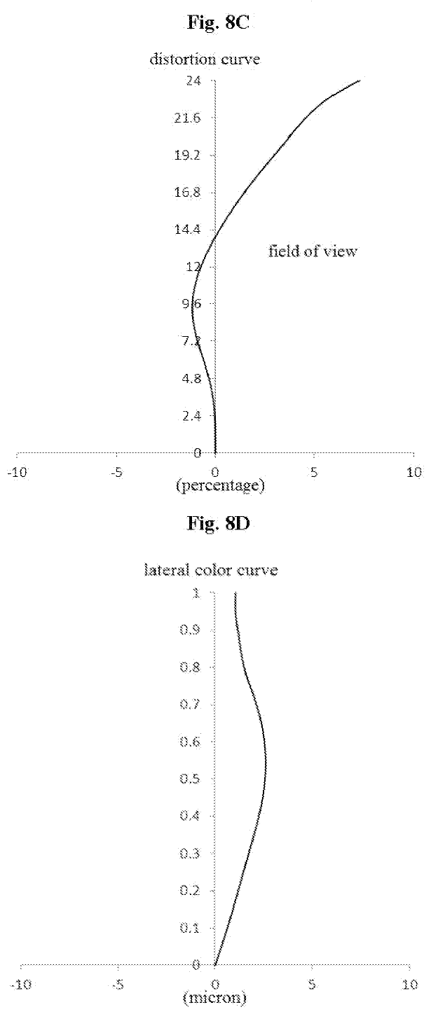

An optical imaging lens assembly according to Embodiment 4 of the disclosure will be described below with reference to FIGS. 7-8D. FIG. 7 is a structure diagram of an optical imaging lens assembly according to Embodiment 4 of the disclosure.

As shown in FIG. 7, the optical imaging lens assembly sequentially includes, from an object side to an image side along an optical axis, a diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, while an image-side surface S2 is a concave surface. The second lens E2 has a negative refractive power, an object-side surface S3 thereof is a convex surface, while an image-side surface S4 is a concave surface. The third lens E3 has a positive refractive power, an object-side surface S5 thereof is a convex surface, while an image-side surface S6 is a concave surface. The fourth lens E4 has a positive refractive power, an object-side surface S7 thereof is a convex surface, while an image-side surface S8 is a concave surface. The fifth lens E5 has a negative refractive power, an object-side surface S9 thereof is a concave surface, while an image-side surface S10 is a convex surface. The sixth lens E6 has a positive refractive power, an object-side surface S11 thereof is a convex surface, while an image-side surface S12 is a concave surface. The seventh lens E7 has a negative refractive power, an object-side surface S13 thereof is a concave surface, while an image-side surface S14 is a concave surface. The optical filter E8 has an object-side surface S15 and an image-side surface S16. Light from an object sequentially penetrates through each of the surfaces S1 to S16, and is finally imaged on the imaging surface S17.

In the embodiment, a total effective focal length f of the optical imaging lens is 7.48 mm. TTL is a distance from the object-side surface S1 of the first lens E1 to the imaging surface S17 on the optical axis, and TTL is 8.03 mm. ImgH is a half of a diagonal length of an effective pixel region on the imaging surface S17, and ImgH is 3.53 mm.

Table 7 shows a table of basic parameters for the optical imaging lens assembly of Embodiment 4, and units of the curvature radius, the thickness/distance and the focal length are all millimeter (mm).

TABLE 7

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | Infinite | | | | |
| STO | Spherical | Infinite | −0.9000 | | | | |
| S1 | Aspheric | 3.0671 | 1.8132 | 1.54 | 55.7 | 6.48 | 0.0000 |
| S2 | Aspheric | 20.7144 | 0.0300 | | | | 0.0000 |
| S3 | Aspheric | 4.0635 | 0.2500 | 1.68 | 19.2 | −8.99 | 0.0000 |
| S4 | Aspheric | 2.3768 | 0.0300 | | | | 0.0000 |
| S5 | Aspheric | 3.3385 | 0.9454 | 1.54 | 55.7 | 25.96 | 0.0000 |
| S6 | Aspheric | 3.9562 | 0.4031 | | | | 0.0000 |
| S7 | Aspheric | 1.9802 | 0.2500 | 1.54 | 55.7 | 23.85 | 0.0000 |
| S8 | Aspheric | 2.2393 | 0.7931 | | | | 0.0000 |
| S9 | Aspheric | −11.1808 | 0.2500 | 1.65 | 23.5 | −18.43 | 0.0000 |
| S10 | Aspheric | −197.1220 | 0.5129 | | | | 0.0000 |
| S11 | Aspheric | 4.5892 | 0.6367 | 1.68 | 19.2 | 9.37 | 0.0000 |
| S12 | Aspheric | 15.6361 | 1.0855 | | | | 0.0000 |
| S13 | Aspheric | −10.4998 | 0.2500 | 1.54 | 55.7 | −5.67 | 0.0000 |
| S14 | Aspheric | 4.3184 | 0.0300 | | | | 0.0000 |
| S15 | Spherical | Infinite | 0.2100 | 1.52 | 64.2 | | |
| S16 | Spherical | Infinite | 0.5400 | | | | |
| S17 | Spherical | Infinite | | | | | |

In Embodiment 4, both the object-side surface and image-side surface of any lens in the first lens E1 to the seventh lens E7 are aspheric surfaces. Table 8 shows higher-order coefficients A₄, A₆, A₈, A₁₀, A₁₂, A₁₄ and A₁₆ that can be used for each of the aspheric mirror surfaces S1-S14 in Embodiment 4.

TABLE 8

| Surface | | | | | | | |
|---|---|---|---|---|---|---|---|
| number | A4 | A6 | A8 | A10 | A12 | A14 | A16 |
| S1 | −1.5860E−02 | 2.5703E−02 | −1.6010E−02 | 4.8510E−03 | −7.7000E−04 | 6.1639E−05 | −1.9629E−06 |
| S2 | 1.4195E−02 | −1.9200E−03 | 5.9600E−04 | −2.8000E−04 | 5.6800E−05 | −5.1193E−06 | 1.7013E−07 |
| S3 | −7.3800E−03 | −1.9300E−03 | 2.9420E−03 | −1.2400E−03 | 2.3400E−04 | −2.0327E−05 | 6.5088E−07 |
| S4 | −3.1280E−02 | 2.4524E−02 | −1.4840E−02 | 5.5870E−03 | −1.3600E−03 | 1.9098E−04 | −1.1550E−05 |
| S5 | −1.2610E−02 | 2.9319E−02 | −1.5750E−02 | 4.1610E−03 | −5.4000E−04 | 2.9722E−05 | −2.5467E−07 |
| S6 | −4.2610E−02 | 2.8567E−02 | −1.6990E−02 | 7.1820E−03 | −1.9400E−03 | 3.0619E−04 | −2.1008E−05 |
| S7 | −7.1350E−02 | 2.0317E−02 | −3.1490E−02 | 2.1673E−02 | −8.3500E−03 | 1.7479E−03 | −1.5483E−04 |
| S8 | −3.5510E−02 | −4.3900E−03 | −4.6000E−04 | −1.3900E−03 | 1.3860E−03 | −3.9948E−04 | 3.8130E−05 |
| S9 | −5.2820E−02 | 4.2213E−02 | −2.6490E−02 | 1.3024E−02 | −4.8100E−03 | 1.0045E−03 | −8.6629E−05 |
| S10 | −8.0330E−02 | 5.9487E−02 | −3.6110E−02 | 1.6712E−02 | −5.3000E−03 | 9.6519E−04 | −7.2060E−05 |
| S11 | −3.6830E−02 | 2.4080E−03 | 2.5990E−03 | −1.9800E−03 | 5.5500E−04 | −6.7063E−05 | 2.9664E−06 |
| S12 | −1.5750E−02 | −2.7800E−03 | 2.6880E−03 | −1.1900E−03 | 2.4800E−04 | −2.3502E−05 | 8.2841E−07 |
| S13 | −2.1400E−01 | 1.3552E−01 | −5.0320E−02 | 1.1719E−02 | −1.6900E−03 | 1.3578E−04 | −4.5052E−06 |
| S14 | −2.3511E−01 | 1.2148E−01 | −3.7550E−02 | 7.2000E−03 | −8.4000E−04 | 5.4416E−05 | −1.4708E−06 |

FIG. 8A shows a longitudinal aberration curve of the optical imaging lens assembly according to Embodiment 4 to represent deviations of a convergence focal point after light with different wavelengths passes through the lens assembly. FIG. 8B shows an astigmatism curve of the optical imaging lens assembly according to Embodiment 4 to represent a tangential image surface curvature and a sagittal image surface curvature. FIG. 8C shows a distortion curve of the optical imaging lens assembly according to Embodiment 4 to represent distortion values corresponding to different fields of view. FIG. 8D shows a lateral color curve of the optical imaging lens assembly according to Embodiment 4 to represent deviations of different image heights on the imaging surface after the light passes through the lens assembly. According to FIGS. 8A-8D, it can be seen that the optical imaging lens assembly provided in Embodiment 4 may achieve high imaging quality.

### Embodiment 5

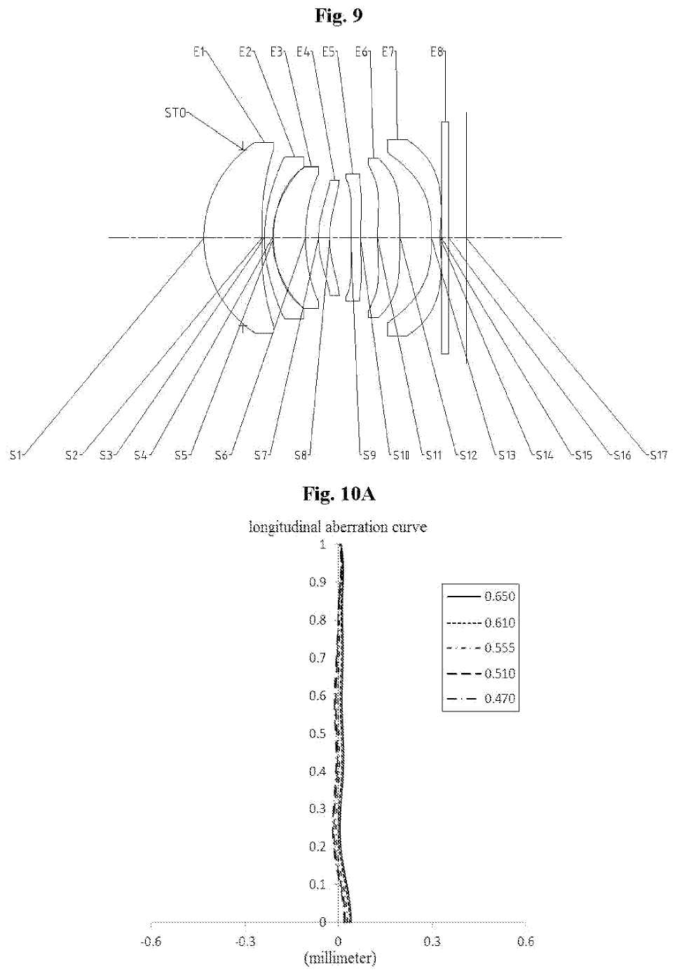

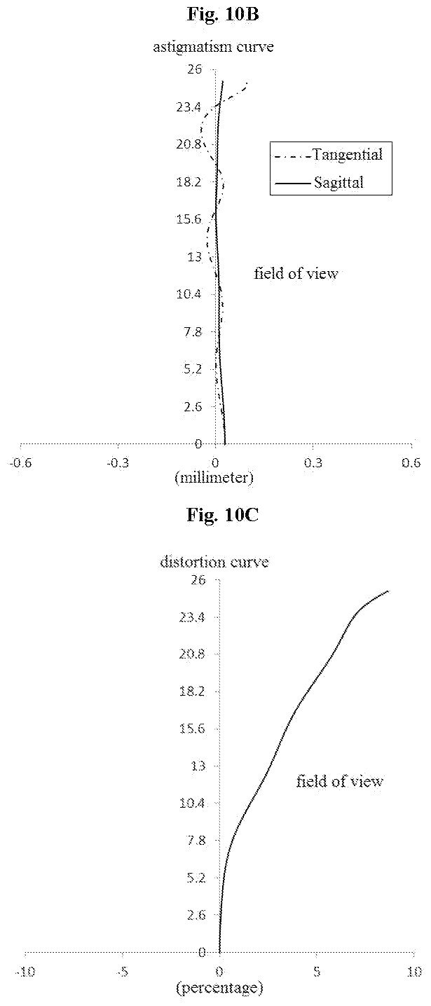

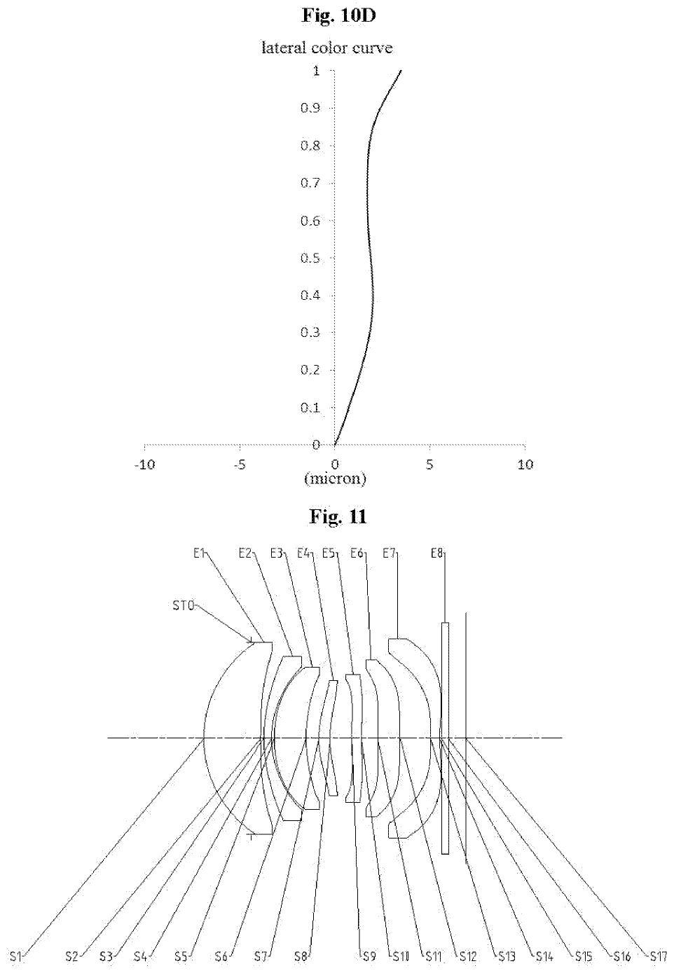

An optical imaging lens assembly according to Embodiment 5 of the disclosure will be described below with reference to FIGS. 9-10D. FIG. 9 is a structure diagram of an optical imaging lens assembly according to Embodiment 5 of the disclosure.

As shown in FIG. 9, the optical imaging lens assembly sequentially includes, from an object side to an image side along an optical axis, a diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, while an image-side surface S2 is a concave surface. The second lens E2 has a negative refractive power, an object-side surface S3 thereof is a convex surface, while an image-side surface S4 is a concave surface. The third lens E3 has a positive refractive power, an object-side surface S5 thereof is a convex surface, while an image-side surface S6 is a concave surface. The fourth lens E4 has a positive refractive power, an object-side surface S7 thereof is a convex surface, while an image-side surface S8 is a concave surface. The fifth lens E5 has a negative refractive power, an object-side surface S9 thereof is a convex surface, while an image-side surface S10 is a concave surface. The sixth lens E6 has a positive refractive power, an object-side surface S11 thereof is a convex surface, while an image-side surface S12 is a convex surface. The seventh lens E7 has a negative refractive power, an object-side surface S13 thereof is a concave surface, while an image-side surface S14 is a concave surface. The optical filter E8 has an object-side surface S15 and an image-side surface S16. Light from an object sequentially penetrates through each of the surfaces S1 to S16, and is finally imaged on the imaging surface S17.

In the embodiment, a total effective focal length f of the optical imaging lens is 7.30 mm. TTL is a distance from the object-side surface S1 of the first lens E1 to the imaging surface S17 on the optical axis, and TTL is 8.20 mm. ImgH is a half of a diagonal length of an effective pixel region on the imaging surface S17, and ImgH is 3.70 mm.

Table 9 shows a table of basic parameters for the optical imaging lens assembly of Embodiment 5, and units of the curvature radius, the thickness/distance and the focal length are all millimeter (mm).

TABLE 9

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | Infinite | | | | |
| STO | Spherical | Infinite | −1.2280 | | | | |
| S1 | Aspheric | 3.1982 | 1.8094 | 1.54 | 55.7 | 6.91 | 0.0000 |
| S2 | Aspheric | 18.6777 | 0.0845 | | | | 0.0000 |
| S3 | Aspheric | 3.7370 | 0.2538 | 1.68 | 19.2 | −9.34 | 0.0000 |
| S4 | Aspheric | 2.2850 | 0.0300 | | | | −1.0000 |
| S5 | Aspheric | 3.2366 | 0.9943 | 1.54 | 55.7 | 24.09 | 0.0000 |
| S6 | Aspheric | 3.8543 | 0.4148 | | | | 0.0000 |
| S7 | Aspheric | 2.5174 | 0.3500 | 1.54 | 55.7 | 21.76 | 0.0000 |
| S8 | Aspheric | 3.0535 | 0.6588 | | | | 0.0000 |
| S9 | Aspheric | 9.8808 | 0.3000 | 1.65 | 23.5 | −32.81 | 0.0000 |
| S10 | Aspheric | 6.6510 | 0.5337 | | | | 0.0000 |
| S11 | Aspheric | 10.7919 | 0.7000 | 1.68 | 19.2 | 10.82 | 0.0000 |
| S12 | Aspheric | −22.2435 | 0.9803 | | | | 0.0000 |
| S13 | Aspheric | −14.3324 | 0.2800 | 1.54 | 55.7 | −6.78 | 0.0000 |
| S14 | Aspheric | 4.9103 | 0.0442 | | | | 0.0000 |
| S15 | Spherical | Infinite | 0.2100 | 1.52 | 64.2 | | |
| S16 | Spherical | Infinite | 0.5562 | | | | |
| S17 | Spherical | Infinite | | | | | |

In Embodiment 5, both the object-side surface and image-side surface of any lens in the first lens E1 to the seventh lens E7 are aspheric surfaces. Table 10 shows higher-order coefficients A₄, A₆, A₈, A₁₀, A₁₂, A₁₄, A₁₆, A₁₈ and A₂₀ that can be used for each of the aspheric mirror surfaces S1-S14 in Embodiment 5.

TABLE 10

| Surface | | | | | |
|---|---|---|---|---|---|
| number | A4 | A6 | A8 | A10 | A12 |
| S1 | −8.0000E−05 | −1.1100E−03 | 8.6500E−04 | −4.0000E−04 | 1.1532E−04 |
| S2 | 1.4770E−03 | 4.6180E−03 | −1.5700E−03 | 1.5800E−04 | 1.2447E−05 |
| S3 | −2.5770E−02 | 8.6110E−03 | 1.5040E−03 | −2.5300E−03 | 9.6299E−04 |
| S4 | −3.1730E−02 | 2.8700E−02 | −2.0310E−02 | 1.2428E−02 | −5.2970E−03 |
| S5 | −1.2380E−02 | 2.5993E−02 | −2.2570E−02 | 1.2849E−02 | −4.4918E−03 |
| S6 | −2.7180E−02 | 2.1536E−02 | −1.8960E−02 | 1.2620E−02 | −5.7405E−03 |
| S7 | −4.0080E−02 | 6.4310E−03 | 4.2900E−04 | −4.7800E−03 | 3.0861E−03 |
| S8 | −2.6330E−02 | 8.5610E−03 | −1.1000E−02 | 1.0444E−02 | −8.2376E−03 |
| S9 | −4.6370E−02 | −1.0290E−02 | 5.4317E−02 | −7.3520E−02 | 5.6584E−02 |
| S10 | −5.9060E−02 | 1.8329E−02 | −4.0900E−03 | 8.3000E−04 | −9.5250E−04 |
| S11 | −1.7210E−02 | −3.9400E−03 | −3.8000E−04 | 1.9930E−03 | −1.6007E−03 |
| S12 | −6.5400E−03 | 5.2530E−03 | −1.1680E−02 | 7.7000E−03 | −2.8176E−03 |
| S13 | −1.1430E−01 | 8.1783E−02 | −5.1550E−02 | 2.3219E−02 | −7.1725E−03 |
| S14 | −1.2080E−01 | 6.9020E−02 | −3.1090E−02 | 9.6440E−03 | −2.0534E−03 |

| Surface | | | | |
|---|---|---|---|---|
| number | A14 | A16 | A18 | A20 |
| S1 | −2.0000E−05 | 2.1600E−06 | −1.2000E−07 | 2.9731E−09 |
| S2 | −3.4000E−06 | 9.3300E−08 | 1.6600E−08 | −9.3285E−10 |
| S3 | −1.9000E−04 | 2.1300E−05 | −1.3000E−06 | 3.2948E−08 |
| S4 | 1.4190E−03 | −2.3000E−04 | 1.9500E−05 | −7.0662E−07 |
| S5 | 9.2300E−04 | −1.0000E−04 | 4.7100E−06 | −1.0360E−08 |
| S6 | 1.7270E−03 | −3.2000E−04 | 3.2900E−05 | −1.4246E−06 |
| S7 | −9.3000E−04 | 1.6200E−04 | −1.7000E−05 | 9.7081E−07 |
| S8 | 4.0750E−03 | −1.1400E−03 | 1.6700E−04 | −9.8943E−06 |
| S9 | −2.6920E−02 | 7.7760E−03 | −1.2500E−03 | 8.4404E−05 |
| S10 | 6.9600E−04 | −2.2000E−04 | 3.1000E−05 | −1.6872E−06 |
| S11 | 5.9100E−04 | −1.1000E−04 | 9.9000E−06 | −3.5256E−07 |
| S12 | 6.0400E−04 | −7.5000E−05 | 4.9300E−06 | −1.3465E−07 |
| S13 | 1.4700E−03 | −1.9000E−04 | 1.4000E−05 | −4.4236E−07 |
| S14 | 2.9500E−04 | −2.7000E−05 | 1.4200E−06 | −3.2285E−08 |

FIG. 10A shows a longitudinal aberration curve of the optical imaging lens assembly according to Embodiment 5 to represent deviations of a convergence focal point after light with different wavelengths passes through the lens assembly. FIG. 10B shows an astigmatism curve of the optical imaging lens assembly according to Embodiment 5 to represent a tangential image surface curvature and a sagittal image surface curvature. FIG. 10C shows a distortion curve of the optical imaging lens assembly according to Embodiment 5 to represent distortion values corresponding to different fields of view. FIG. 10D shows a lateral color curve of the optical imaging lens assembly according to Embodiment 5 to represent deviations of different image heights on the imaging surface after the light passes through the lens assembly. According to FIGS. 10A-10D, it can be seen that the optical imaging lens assembly provided in Embodiment 5 may achieve high imaging quality.

### Embodiment 6

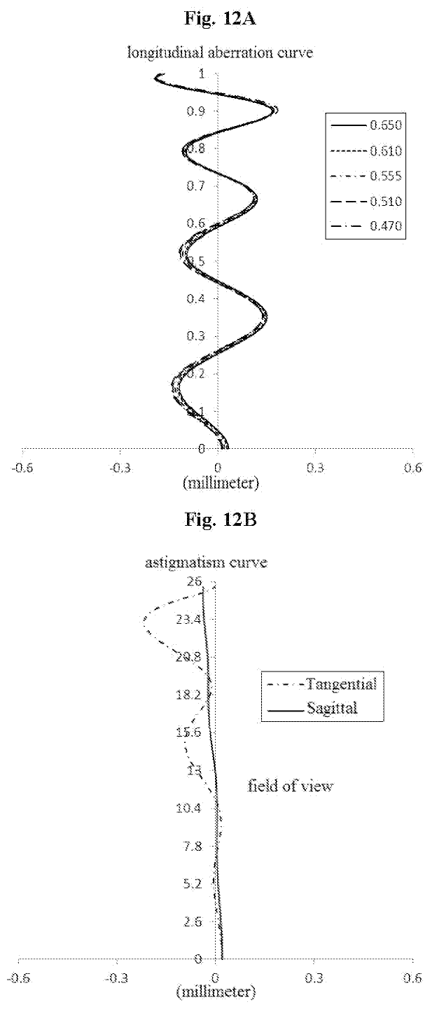

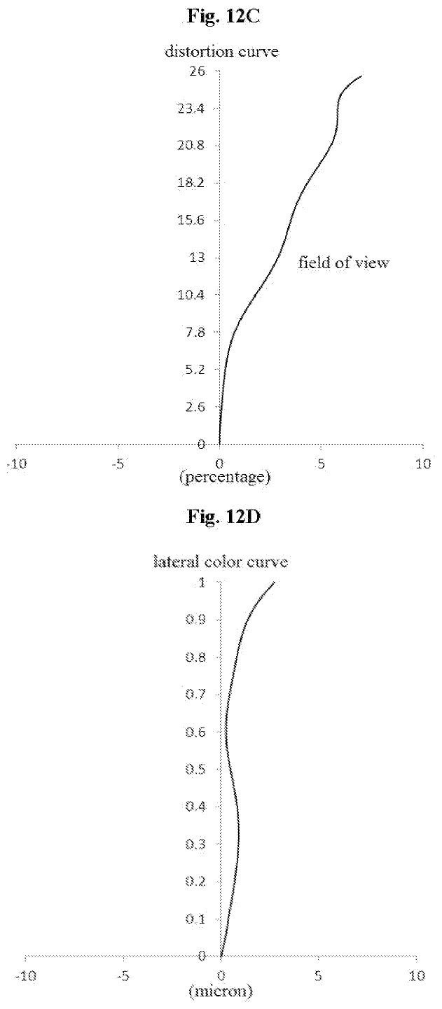

An optical imaging lens assembly according to Embodiment 6 of the disclosure will be described below with reference to FIGS. 11-12D. FIG. 11 is a structure diagram of an optical imaging lens assembly according to Embodiment 6 of the disclosure.

As shown in FIG. 11, the optical imaging lens assembly sequentially includes, from an object side to an image side along an optical axis, a diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, while an image-side surface S2 is a concave surface. The second lens E2 has a negative refractive power, an object-side surface S3 thereof is a convex surface, while an image-side surface S4 is a concave surface. The third lens E3 has a positive refractive power, an object-side surface S5 thereof is a convex surface, while an image-side surface S6 is a concave surface. The fourth lens E4 has a positive refractive power, an object-side surface S7 thereof is a convex surface, while an image-side surface S8 is a concave surface. The fifth lens E5 has a negative refractive power, an object-side surface S9 thereof is a convex surface, while an image-side surface S10 is a concave surface. The sixth lens E6 has a positive refractive power, an object-side surface S11 thereof is a convex surface, while an image-side surface S12 is a convex surface. The seventh lens E7 has a negative refractive power, an object-side surface S13 thereof is a concave surface, while an image-side surface S14 is a concave surface. The optical filter E8 has an object-side surface S15 and an image-side surface S16. Light from an object sequentially penetrates through each of the surfaces S1 to S16, and is finally imaged on the imaging surface S17.

In the embodiment, a total effective focal length f of the optical imaging lens is 7.30 mm. TTL is a distance from the object-side surface S1 of the first lens E1 to the imaging surface S17 on the optical axis, and TTL is 8.20 mm. ImgH is a half of a diagonal length of an effective pixel region on the imaging surface S17, and ImgH is 3.70 mm.

Table 11 shows a table of basic parameters for the optical imaging lens assembly of Embodiment 6, and units of the curvature radius, the thickness/distance and the focal length are all millimeter (mm).

TABLE 11

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | Infinite | | | | |
| STO | Spherical | Infinite | −1.4853 | | | | |
| S1 | Aspheric | 3.1941 | 1.7721 | 1.54 | 55.7 | 6.83 | 0.0000 |
| S2 | Aspheric | 19.9432 | 0.1037 | | | | 0.0000 |
| S3 | Aspheric | 3.9384 | 0.2391 | 1.68 | 19.2 | −9.72 | 0.0000 |
| S4 | Aspheric | 2.4045 | 0.0880 | | | | 0.0000 |
| S5 | Aspheric | 3.3448 | 0.9906 | 1.54 | 55.7 | 26.28 | 0.0000 |
| S6 | Aspheric | 3.9313 | 0.4034 | | | | 0.0000 |
| S7 | Aspheric | 2.7416 | 0.3500 | 1.54 | 55.7 | 19.87 | 0.0000 |
| S8 | Aspheric | 3.5261 | 0.6799 | | | | 0.0000 |
| S9 | Aspheric | 10.8413 | 0.3000 | 1.65 | 23.5 | −41.98 | 0.0000 |
| S10 | Aspheric | 7.6528 | 0.5086 | | | | 0.0000 |
| S11 | Aspheric | 18.2833 | 0.7000 | 1.68 | 19.2 | 13.89 | 0.0000 |
| S12 | Aspheric | −19.1053 | 0.9523 | | | | 0.0000 |
| S13 | Aspheric | −8133.7500 | 0.2800 | 1.54 | 55.7 | −6.90 | 0.0000 |
| S14 | Aspheric | 3.7063 | 0.0661 | | | | 0.0000 |
| S15 | Spherical | Infinite | 0.2100 | 1.52 | 64.2 | | |
| S16 | Spherical | Infinite | 0.5562 | | | | |
| S17 | Spherical | Infinite | | | | | |

In Embodiment 6, both the object-side surface and image-side surface of any lens in the first lens E1 to the seventh lens E7 are aspheric surfaces. Table 12 shows higher-order coefficients A₄, A₆, A₈, A₁₀, A₁₂, A₁₄, A₁₆, A₁₈ and A₂₀ that can be used for each of the aspheric mirror surfaces S1-S14 in Embodiment 6.

TABLE 12

| Surface | | | | | |
|---|---|---|---|---|---|
| number | A4 | A6 | A8 | A10 | A12 |
| S1 | −2.8000E−04 | −6.3000E−04 | 4.5602E−04 | −2.1000E−04 | 5.9810E−05 |
| S2 | 6.8990E−03 | −2.7000E−04 | 9.1702E−04 | −6.5000E−04 | 1.8746E−04 |
| S3 | −2.0440E−02 | 3.6800E−03 | 4.0536E−03 | −3.2800E−03 | 1.0904E−03 |
| S4 | −6.1640E−02 | 1.5317E−01 | −2.4112E−01 | 2.0437E−01 | −1.0025E−01 |
| S5 | 5.5700E−03 | 8.7200E−04 | −7.4831E−04 | 7.8700E−04 | −1.5717E−04 |
| S6 | −2.1060E−02 | 1.5167E−02 | −1.3496E−02 | 9.3100E−03 | −4.2843E−03 |
| S7 | −3.5430E−02 | 6.1380E−03 | −2.8003E−03 | −7.0000E−04 | 8.3986E−04 |
| S8 | −2.3550E−02 | 5.1080E−03 | −6.6302E−03 | 5.0390E−03 | −3.5689E−03 |
| S9 | −4.2500E−02 | −4.3900E−03 | 3.2975E−02 | −4.6870E−02 | 3.7252E−02 |
| S10 | −5.0740E−02 | 1.5564E−02 | −9.0616E−03 | 8.8960E−03 | −6.5867E−03 |
| S11 | −1.7260E−02 | −1.2720E−02 | 9.3483E−03 | −3.0300E−03 | −4.3825E−04 |
| S12 | −9.9900E−03 | 4.4320E−03 | −9.7025E−03 | 6.1070E−03 | −2.1198E−03 |
| S13 | −1.3298E−01 | 9.6489E−02 | −6.3098E−02 | 2.9728E−02 | −9.5335E−03 |
| S14 | −1.3789E−01 | 7.7926E−02 | −3.5053E−02 | 1.0950E−02 | −2.3609E−03 |

| Surface | | | | |
|---|---|---|---|---|
| number | A14 | A16 | A18 | A20 |
| S1 | −1.1000E−05 | 1.1600E−06 | −6.8000E−08 | 1.6239E−09 |
| S2 | −2.9000E−05 | 2.4500E−06 | −1.1000E−07 | 1.9620E−09 |
| S3 | −2.0000E−04 | 2.1500E−05 | −1.3000E−06 | 3.1008E−08 |
| S4 | 2.9405E−02 | −5.0900E−03 | 4.8100E−04 | −1.9058E−05 |
| S5 | −8.4000E−05 | 4.4400E−05 | −7.3000E−06 | 4.2276E−07 |
| S6 | 1.2770E−03 | −2.3000E−04 | 2.2800E−05 | −9.3738E−07 |
| S7 | −2.6000E−04 | 5.1300E−05 | −7.9000E−06 | 6.3711E−07 |
| S8 | 1.6910E−03 | −4.5000E−04 | 6.0100E−05 | −3.1768E−06 |
| S9 | −1.8270E−02 | 5.4270E−03 | −8.9000E−04 | 6.1159E−05 |
| S10 | 2.8880E−03 | −7.0000E−04 | 8.7900E−05 | −4.4378E−06 |
| S11 | 5.4200E−04 | −1.4000E−04 | 1.4600E−05 | −5.8653E−07 |
| S12 | 4.2700E−04 | −4.9000E−05 | 2.9700E−06 | −7.3573E−08 |
| S13 | 1.9980E−03 | −2.6000E−04 | 1.9000E−05 | −5.9436E−07 |
| S14 | 3.4200E−04 | −3.1000E−05 | 1.6400E−06 | −3.6744E−08 |

FIG. 12A shows a longitudinal aberration curve of the optical imaging lens assembly according to Embodiment 6 to represent deviations of a convergence focal point after light with different wavelengths passes through the lens assembly. FIG. 12B shows an astigmatism curve of the optical imaging lens assembly according to Embodiment 6 to represent a tangential image surface curvature and a sagittal image surface curvature. FIG. 12C shows a distortion curve of the optical imaging lens assembly according to Embodiment 6 to represent distortion values corresponding to different fields of view. FIG. 12D shows a lateral color curve of the optical imaging lens assembly according to Embodiment 6 to represent deviations of different image heights on the imaging surface after the light passes through the lens assembly. According to FIGS. 12A-12D, it can be seen that the optical imaging lens assembly provided in Embodiment 6 may achieve high imaging quality.

### Embodiment 7

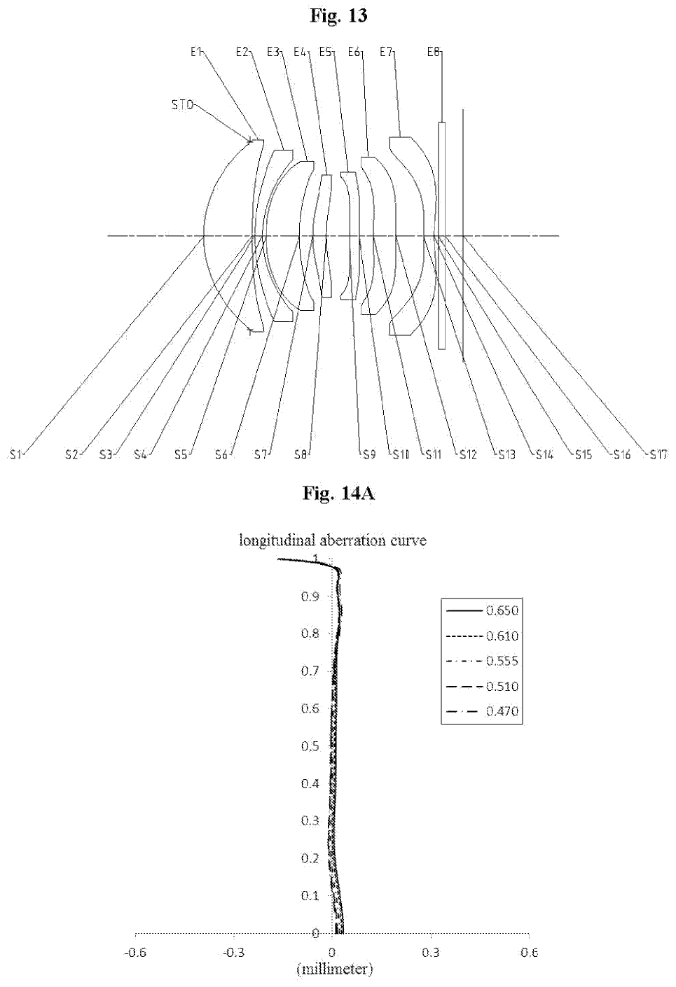

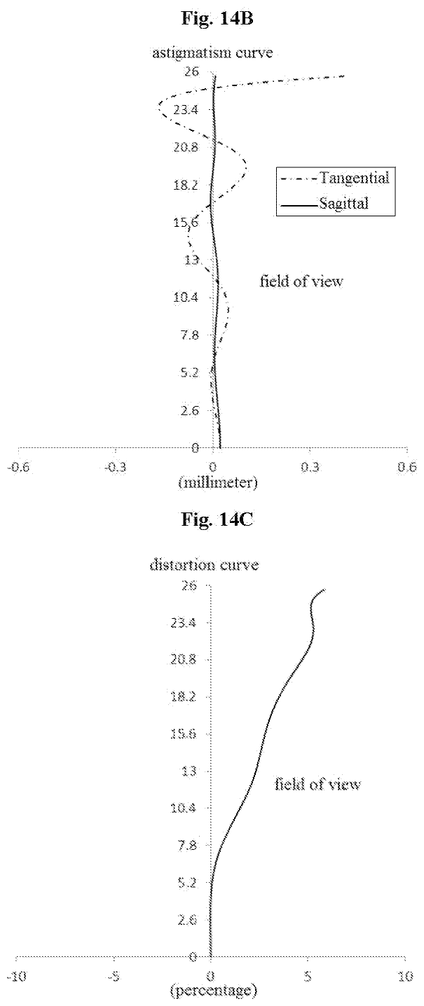

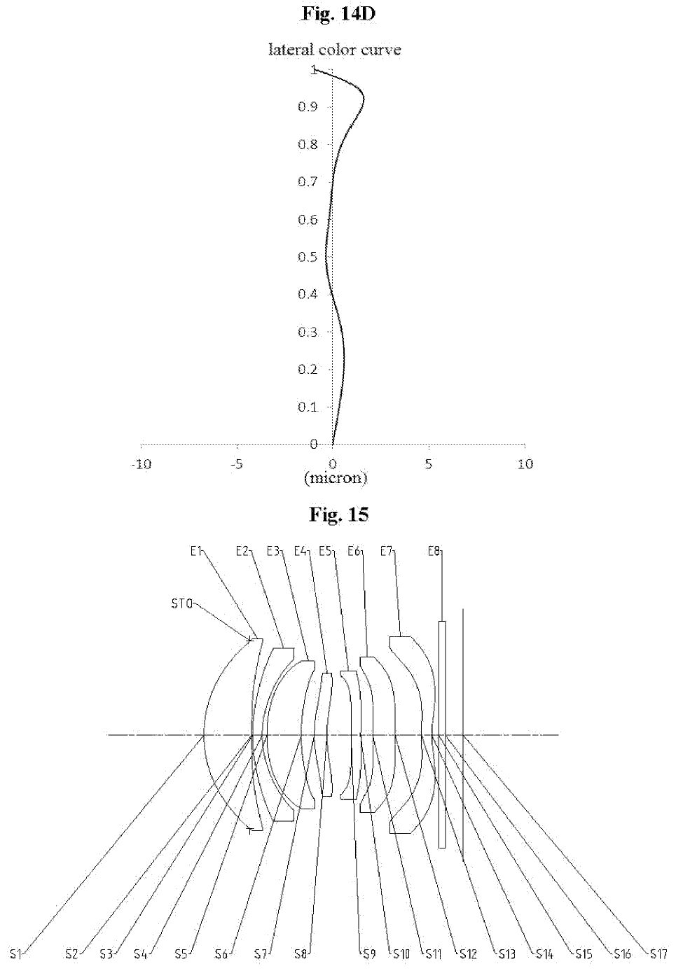

An optical imaging lens assembly according to Embodiment 7 of the disclosure will be described below with reference to FIGS. 13-14D. FIG. 13 is a structure diagram of an optical imaging lens assembly according to Embodiment 7 of the disclosure.

As shown in FIG. 13, the optical imaging lens assembly sequentially includes, from an object side to an image side along an optical axis, a diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, while an image-side surface S2 is a concave surface. The second lens E2 has a negative refractive power, an object-side surface S3 thereof is a convex surface, while an image-side surface S4 is a concave surface. The third lens E3 has a positive refractive power, an object-side surface S5 thereof is a convex surface, while an image-side surface S6 is a concave surface. The fourth lens E4 has a positive refractive power, an object-side surface S7 thereof is a convex surface, while an image-side surface S8 is a concave surface. The fifth lens E5 has a negative refractive power, an object-side surface S9 thereof is a convex surface, while an image-side surface S10 is a concave surface. The sixth lens E6 has a positive refractive power, an object-side surface S11 thereof is a convex surface, while an image-side surface S12 is a concave surface. The seventh lens E7 has a negative refractive power, an object-side surface S13 thereof is a convex surface, while an image-side surface S14 is a concave surface. The optical filter E8 has an object-side surface S15 and an image-side surface S16. Light from an object sequentially penetrates through each of the surfaces S1 to S16, and is finally imaged on the imaging surface S17.

In the embodiment, a total effective focal length f of the optical imaging lens is 7.30 mm. TTL is a distance from the object-side surface S1 of the first lens E1 to the imaging surface S17 on the optical axis, and TTL is 8.10 mm. ImgH is a half of a diagonal length of an effective pixel region on the imaging surface S17, and ImgH is 3.70 mm.

Table 13 shows a table of basic parameters for the optical imaging lens assembly of Embodiment 7, and units of the curvature radius, the thickness/distance and the focal length are all millimeter (mm).

TABLE 13

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | Infinite | | | | |
| STO | Spherical | Infinite | −1.4457 | | | | |
| S1 | Aspheric | 3.1802 | 1.5164 | 1.54 | 55.7 | 6.54 | 0.0000 |
| S2 | Aspheric | 28.0923 | 0.0796 | | | | 0.0000 |
| S3 | Aspheric | 4.3405 | 0.2385 | 1.68 | 19.2 | −10.96 | 0.0000 |
| S4 | Aspheric | 2.6783 | 0.1182 | | | | 0.0000 |
| S5 | Aspheric | 3.8388 | 1.0350 | 1.54 | 55.7 | 40.42 | 0.0000 |
| S6 | Aspheric | 4.2250 | 0.4185 | | | | 0.0000 |
| S7 | Aspheric | 3.0386 | 0.4232 | 1.54 | 55.7 | 21.01 | 0.0000 |
| S8 | Aspheric | 3.9570 | 0.7241 | | | | 0.0000 |
| S9 | Aspheric | 21.4033 | 0.3000 | 1.65 | 23.5 | −61.52 | 0.0000 |
| S10 | Aspheric | 13.8157 | 0.4548 | | | | 0.0000 |
| S11 | Aspheric | 15.1272 | 0.7000 | 1.68 | 19.2 | 22.34 | 0.0000 |
| S12 | Aspheric | 30327.8800 | 0.8678 | | | | 0.0000 |
| S13 | Aspheric | 16.2061 | 0.3200 | 1.54 | 55.7 | −7.49 | 0.0000 |
| S14 | Aspheric | 3.1984 | 0.1378 | | | | 0.0000 |
| S15 | Spherical | Infinite | 0.2100 | 1.52 | 64.2 | | |
| S16 | Spherical | Infinite | 0.5562 | | | | |
| S17 | Spherical | Infinite | | | | | |

In Embodiment 7, both the object-side surface and image-side surface of any lens in the first lens E1 to the seventh lens E7 are aspheric surfaces. Table 14 shows higher-order coefficients A₄, A₆, A₈, A₁₀, A₁₂, A₁₄, A₁₆, A₁₈ and A₂₀ that can be used for each of the aspheric mirror surfaces S1-S14 in Embodiment 7.

TABLE 14

| Surface | | | | | |
|---|---|---|---|---|---|
| number | A4 | A6 | A8 | A10 | A12 |
| S1 | −5.7200E−04 | −7.3006E−04 | 6.1605E−04 | −3.2000E−04 | 9.7541E−05 |
| S2 | 7.0526E−03 | 2.0885E−03 | −1.7380E−03 | 6.7900E−04 | −1.8554E−04 |
| S3 | −1.4053E−02 | 2.8867E−03 | 8.6483E−04 | −8.8000E−04 | 2.8188E−04 |
| S4 | −1.2207E−02 | −1.4799E−03 | 1.4125E−03 | 6.9600E−05 | −3.5047E−04 |
| S5 | 1.5203E−02 | −3.0718E−03 | 1.3035E−04 | 9.3100E−04 | −5.4402E−04 |
| S6 | −1.8044E−02 | 9.8595E−03 | −6.3519E−03 | 3.9270E−03 | −1.6411E−03 |
| S7 | −3.4402E−02 | 3.0045E−03 | −2.4942E−03 | 1.8540E−03 | −1.0963E−03 |
| S8 | −2.2400E−02 | −2.6690E−04 | −2.1819E−03 | 1.7450E−03 | −8.7652E−04 |
| S9 | −2.5147E−02 | −2.5581E−02 | 7.1300E−02 | −9.7760E−02 | 7.8804E−02 |
| S10 | −4.0980E−02 | 1.8847E−02 | −2.2513E−02 | 2.4963E−02 | −1.7041E−02 |
| S11 | −2.5923E−02 | −1.5930E−02 | 1.5668E−02 | −6.0800E−03 | −1.5227E−04 |
| S12 | −1.7194E−02 | 3.6462E−03 | −7.3090E−03 | 4.5680E−03 | −1.5190E−03 |
| S13 | −1.2891E−01 | 7.6048E−02 | −4.0527E−02 | 1.5979E−02 | −4.3659E−03 |
| S14 | −1.4578E−01 | 8.3922E−02 | −4.1318E−02 | 1.4258E−02 | −3.3132E−03 |

| Surface | | | | |
|---|---|---|---|---|
| number | A14 | A16 | A18 | A20 |
| S1 | −1.9000E−05 | 2.0900E−06 | −1.3000E−07 | 3.2422E−09 |
| S2 | 3.3800E−05 | −3.8000E−06 | 2.2700E−07 | −5.6483E−09 |
| S3 | −4.8000E−05 | 4.6000E−06 | −2.5000E−07 | 5.6912E−09 |
| S4 | 1.4100E−04 | −2.7000E−05 | 2.5700E−06 | −1.0255E−07 |
| S5 | 1.7100E−04 | −3.4000E−05 | 3.9700E−06 | −2.0757E−07 |
| S6 | 4.4100E−04 | −7.0000E−05 | 5.8500E−06 | −1.9380E−07 |
| S7 | 4.6800E−04 | −1.2000E−04 | 1.5000E−05 | −7.4173E−07 |
| S8 | 2.7900E−04 | −4.5000E−05 | 2.2300E−06 | 1.4194E−07 |
| S9 | −3.9330E−02 | 1.1860E−02 | −1.9700E−03 | 1.3886E−04 |
| S10 | 6.7440E−03 | −1.5100E−03 | 1.7600E−04 | −8.4242E−06 |
| S11 | 7.7600E−04 | −2.2000E−04 | 2.5700E−05 | −1.1098E−06 |
| S12 | 2.8000E−04 | −2.7000E−05 | 1.2100E−06 | −1.4354E−08 |
| S13 | 7.9000E−04 | −8.9000E−05 | 5.7500E−06 | −1.5966E−07 |
| S14 | 5.0200E−04 | −4.7000E−05 | 2.4900E−06 | −5.6004E−08 |

FIG. 14A shows a longitudinal aberration curve of the optical imaging lens assembly according to Embodiment 7 to represent deviations of a convergence focal point after light with different wavelengths passes through the lens assembly. FIG. 14B shows an astigmatism curve of the optical imaging lens assembly according to Embodiment 7 to represent a tangential image surface curvature and a sagittal image surface curvature. FIG. 14C shows a distortion curve of the optical imaging lens assembly according to Embodiment 7 to represent distortion values corresponding to different fields of view. FIG. 14D shows a lateral color curve of the optical imaging lens assembly according to Embodiment 7 to represent deviations of different image heights on the imaging surface after the light passes through the lens assembly. According to FIGS. 14A-14D, it can be seen that the optical imaging lens assembly provided in Embodiment 7 may achieve high imaging quality.

### Embodiment 8

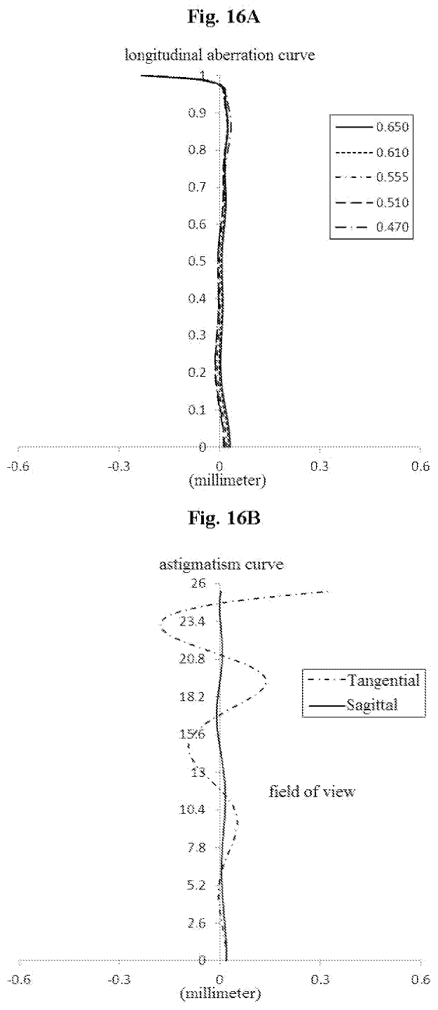

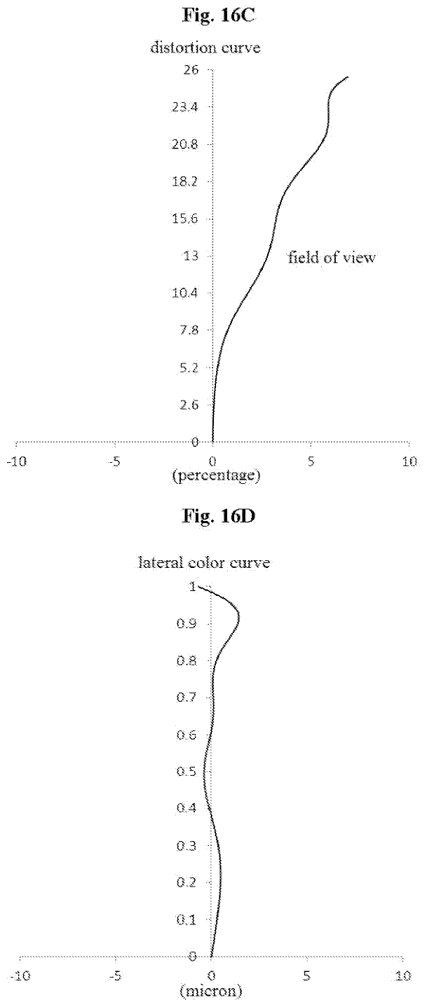

An optical imaging lens assembly according to Embodiment 8 of the disclosure will be described below with reference to FIGS. 15-16D. FIG. 15 is a structure diagram of an optical imaging lens assembly according to Embodiment 8 of the disclosure.

As shown in FIG. 15, the optical imaging lens assembly sequentially includes, from an object side to an image side along an optical axis, a diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, while an image-side surface S2 is a concave surface. The second lens E2 has a negative refractive power, an object-side surface S3 thereof is a convex surface, while an image-side surface S4 is a concave surface. The third lens E3 has a positive refractive power, an object-side surface S5 thereof is a convex surface, while an image-side surface S6 is a concave surface. The fourth lens E4 has a positive refractive power, an object-side surface S7 thereof is a convex surface, while an image-side surface S8 is a concave surface. The fifth lens E5 has a negative refractive power, an object-side surface S9 thereof is a convex surface, while an image-side surface S10 is a concave surface. The sixth lens E6 has a positive refractive power, an object-side surface S11 thereof is a convex surface, while an image-side surface S12 is a convex surface. The seventh lens E7 has a negative refractive power, an object-side surface S13 thereof is a convex surface, while an image-side surface S14 is a concave surface. The optical filter E8 has an object-side surface S15 and an image-side surface S16. Light from an object sequentially penetrates through each of the surfaces S1 to S16, and is finally imaged on the imaging surface S17.

In the embodiment, a total effective focal length f of the optical imaging lens is 7.30 mm. TTL is a distance from the object-side surface S1 of the first lens E1 to the imaging surface S17 on the optical axis, and TTL is 8.10 mm. ImgH is a half of a diagonal length of an effective pixel region on the imaging surface S17, and ImgH is 3.70 mm.

Table 15 shows a table of basic parameters for the optical imaging lens assembly of Embodiment 8, and units of the curvature radius, the thickness/distance and the focal length are all millimeter (mm).

TABLE 15

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | Infinite | | | | |
| STO | Spherical | Infinite | −1.4359 | | | | |
| S1 | Aspheric | 3.1729 | 1.4936 | 1.54 | 55.7 | 6.41 | 0.0000 |
| S2 | Aspheric | 34.3794 | 0.0300 | | | | 0.0000 |
| S3 | Aspheric | 4.2904 | 0.3000 | 1.68 | 19.2 | −10.54 | 0.0000 |
| S4 | Aspheric | 2.6041 | 0.1513 | | | | 0.0000 |
| S5 | Aspheric | 3.9060 | 1.0689 | 1.54 | 55.7 | 29.84 | 0.0000 |
| S6 | Aspheric | 4.6725 | 0.4086 | | | | 0.0000 |
| S7 | Aspheric | 3.2224 | 0.3964 | 1.54 | 55.7 | 27.56 | 0.0000 |
| S8 | Aspheric | 3.9431 | 0.7475 | | | | 0.0000 |
| S9 | Aspheric | 27.7092 | 0.3000 | 1.65 | 23.5 | −47.64 | 0.0000 |
| S10 | Aspheric | 14.4918 | 0.3834 | | | | 0.0000 |
| S11 | Aspheric | 17.8254 | 0.7000 | 1.68 | 19.2 | 22.30 | 0.0000 |
| S12 | Aspheric | −97.4928 | 0.8195 | | | | 0.0000 |
| S13 | Aspheric | 6.1559 | 0.3200 | 1.54 | 55.7 | −8.38 | 0.0000 |
| S14 | Aspheric | 3.1984 | 0.2146 | | | | −1.0000 |
| S15 | Spherical | Infinite | 0.2100 | 1.52 | 64.2 | | |
| S16 | Spherical | Infinite | 0.5567 | | | | |
| S17 | Spherical | Infinite | | | | | |

In Embodiment 8, both the object-side surface and image-side surface of any lens in the first lens E1 to the seventh lens E7 are aspheric surfaces. Table 16 shows higher-order coefficients A₄, A₆, A₈, A₁₀, A₁₂, A₁₄, A₁₆, A₁₈ and A₂₀ that can be used for each of the aspheric mirror surfaces S1-S14 in Embodiment 8.

TABLE 16

| Surface | | | | | |
|---|---|---|---|---|---|
| number | A4 | A6 | A8 | A10 | A12 |
| S1 | −4.8900E−04 | −8.7633E−04 | 7.2484E−04 | −3.7000E−04 | 1.0912E−04 |
| S2 | 9.3695E−03 | 8.2035E−04 | −1.4372E−03 | 6.5500E−04 | −1.8435E−04 |
| S3 | −1.1968E−02 | 4.2376E−03 | −2.1081E−03 | 9.4300E−04 | −3.0136E−04 |
| S4 | −1.4699E−02 | 6.7051E−03 | −7.6913E−03 | 5.0740E−03 | −1.9862E−03 |
| S5 | 1.5076E−02 | −2.1682E−05 | −9.7812E−04 | 9.7800E−05 | 2.6183E−04 |
| S6 | −1.5662E−02 | 1.1301E−02 | −9.5052E−03 | 7.4020E−03 | −3.9422E−03 |
| S7 | −3.7690E−02 | 3.5742E−03 | −1.6839E−03 | 9.2100E−04 | −4.0873E−04 |
| S8 | −2.7158E−02 | 5.4597E−04 | −2.5766E−03 | 2.8770E−03 | −2.0671E−03 |
| S9 | −2.6163E−02 | −1.8541E−02 | 5.8694E−02 | −8.6610E−02 | 7.3474E−02 |
| S10 | −4.3466E−02 | 2.3415E−02 | −2.7082E−02 | 2.7867E−02 | −1.8334E−02 |
| S11 | −2.9679E−02 | −2.0073E−02 | 2.6267E−02 | −1.4590E−02 | 3.2165E−03 |
| S12 | −2.1627E−02 | 4.9666E−03 | −5.9146E−03 | 2.8260E−03 | −6.4753E−04 |
| S13 | −1.4647E−01 | 7.5940E−02 | −3.6146E−02 | 1.3310E−02 | −3.5251E−03 |
| S14 | −1.5168E−01 | 7.4011E−02 | −2.8442E−02 | 7.7600E−03 | −1.4910E−03 |

| Surface | | | | |
|---|---|---|---|---|
| number | A14 | A16 | A18 | A20 |
| S1 | −2.0000E−05 | 2.1600E−06 | −1.3000E−07 | 3.0075E−09 |
| S2 | 3.2000E−05 | −3.2000E−06 | 1.7000E−07 | −3.5368E−09 |
| S3 | 6.1200E−05 | −7.3000E−06 | 4.7300E−07 | −1.2528E−08 |
| S4 | 4.8800E−04 | −7.5000E−05 | 6.6000E−06 | −2.5371E−07 |
| S5 | −1.1000E−04 | 1.4800E−05 | −4.7000E−07 | −3.4722E−08 |
| S6 | 1.3670E−03 | −2.9000E−04 | 3.3500E−05 | −1.6264E−06 |
| S7 | 1.9600E−04 | −6.0000E−05 | 8.9000E−06 | −4.6777E−07 |
| S8 | 1.0030E−03 | −3.0000E−04 | 4.9800E−05 | −3.4432E−06 |
| S9 | −3.8370E−02 | 1.2069E−02 | −2.0900E−03 | 1.5326E−04 |
| S10 | 7.0900E−03 | −1.5500E−03 | 1.7900E−04 | −8.3981E−06 |
| S11 | 8.4000E−05 | −1.5000E−04 | 2.3700E−05 | −1.1791E−06 |
| S12 | 4.0900E−05 | 1.0000E−05 | −1.9000E−06 | 9.1528E−08 |
| S13 | 6.3200E−04 | −7.2000E−05 | 4.6700E−06 | −1.3220E−07 |
| S14 | 1.9800E−04 | −1.7000E−05 | 8.6900E−07 | −1.9245E−08 |

FIG. 16A shows a longitudinal aberration curve of the optical imaging lens assembly according to Embodiment 8 to represent deviations of a convergence focal point after light with different wavelengths passes through the lens assembly. FIG. 16B shows an astigmatism curve of the optical imaging lens assembly according to Embodiment 8 to represent a tangential image surface curvature and a sagittal image surface curvature. FIG. 16C shows a distortion curve of the optical imaging lens according to Embodiment 8 to represent distortion values corresponding to different fields of view. FIG. 16D shows a lateral color curve of the optical imaging lens assembly according to Embodiment 8 to represent deviations of different image heights on the imaging surface after the light passes through the lens assembly. According to FIGS. 16A-16D, it can be seen that the optical imaging lens assembly provided in Embodiment 8 may achieve high imaging quality.

### Embodiment 9

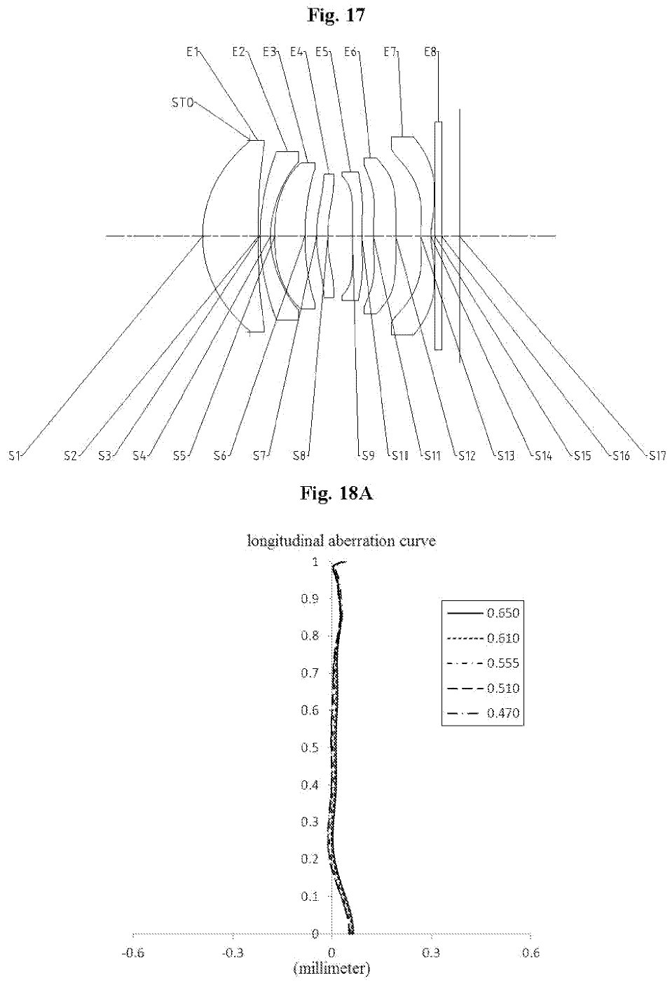

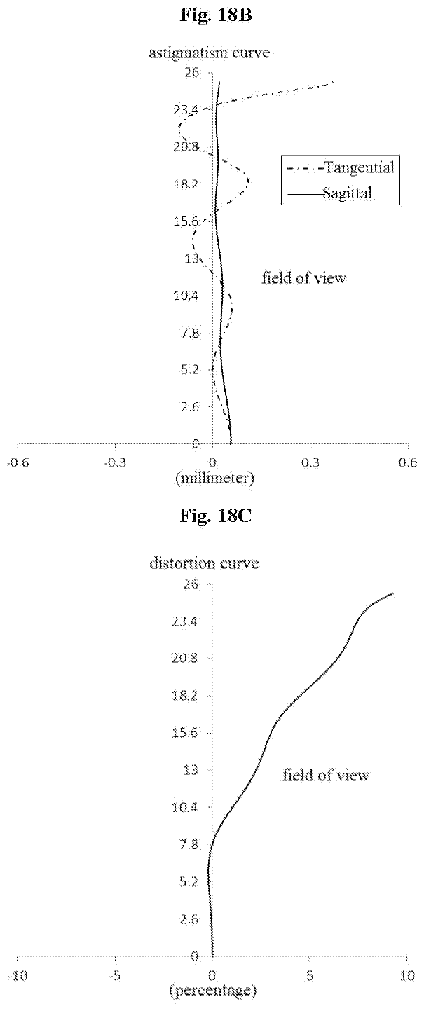

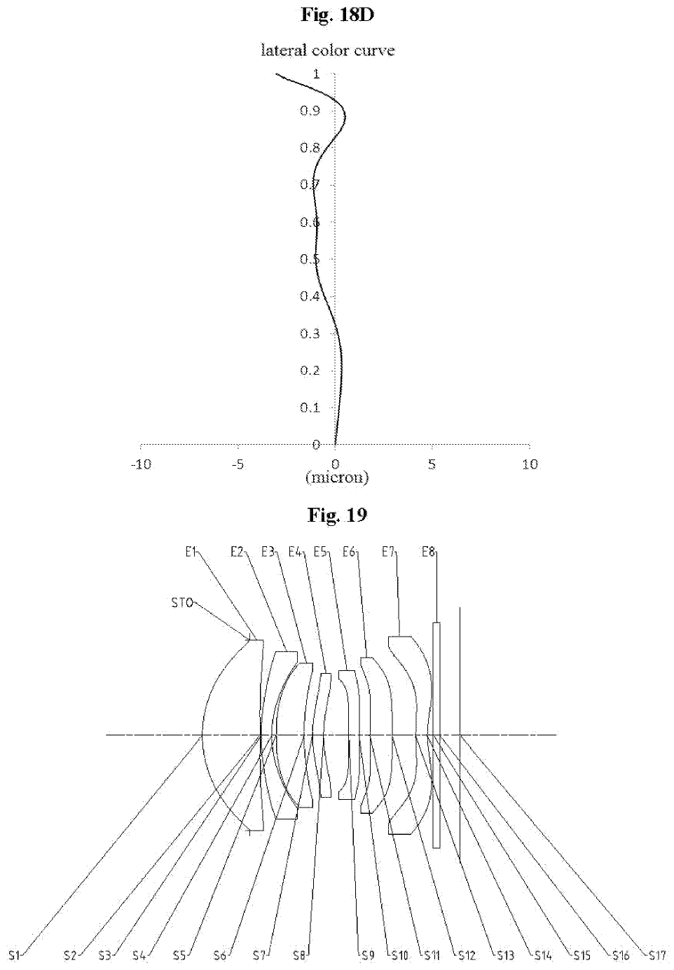

An optical imaging lens assembly according to Embodiment 9 of the disclosure will be described below with reference to FIGS. 17-18D. FIG. 17 is a structure diagram of an optical imaging lens assembly according to Embodiment 9 of the disclosure.

As shown in FIG. 17, the optical imaging lens assembly sequentially includes, from an object side to an image side along an optical axis, a diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, while an image-side surface S2 is a convex surface. The second lens E2 has a negative refractive power, an object-side surface S3 thereof is a convex surface, while an image-side surface S4 is a concave surface. The third lens E3 has a positive refractive power, an object-side surface S5 thereof is a convex surface, while an image-side surface S6 is a concave surface. The fourth lens E4 has a positive refractive power, an object-side surface S7 thereof is a convex surface, while an image-side surface S8 is a concave surface. The fifth lens E5 has a negative refractive power, an object-side surface S9 thereof is a convex surface, while an image-side surface S10 is a concave surface. The sixth lens E6 has a positive refractive power, an object-side surface S11 thereof is a convex surface, while an image-side surface S12 is a concave surface. The seventh lens E7 has a negative refractive power, an object-side surface S13 thereof is a convex surface, while an image-side surface S14 is a concave surface. The optical filter E8 has an object-side surface S15 and an image-side surface S16. Light from an object sequentially penetrates through each of the surfaces S1 to S16, and is finally imaged on the imaging surface S17.

In the embodiment, a total effective focal length f of the optical imaging lens is 7.26 mm. TTL is a distance from the object-side surface S1 of the first lens E1 to the imaging surface S17 on the optical axis, and TTL is 8.03 mm. ImgH is a half of a diagonal length of an effective pixel region on the imaging surface S17, and ImgH is 3.70 mm.

Table 17 shows a table of basic parameters for the optical imaging lens assembly of Embodiment 9, and units of the curvature radius, the thickness/distance and the focal length are all millimeter (mm).

TABLE 17

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | Infinite | | | | |
| STO | Spherical | Infinite | −1.4930 | | | | |
| S1 | Aspheric | 3.1488 | 1.7462 | 1.54 | 55.7 | 5.58 | 0.0000 |
| S2 | Aspheric | −50.0750 | 0.0437 | | | | 0.0000 |
| S3 | Aspheric | 4.8462 | 0.3299 | 1.68 | 19.2 | −9.06 | 0.0000 |
| S4 | Aspheric | 2.6339 | 0.1274 | | | | 0.0000 |
| S5 | Aspheric | 4.7152 | 0.9507 | 1.54 | 55.7 | 36.19 | 0.0000 |
| S6 | Aspheric | 5.7885 | 0.3649 | | | | 0.0000 |
| S7 | Aspheric | 3.3210 | 0.3501 | 1.54 | 55.7 | 48.23 | 0.0000 |
| S8 | Aspheric | 3.6695 | 0.7600 | | | | 0.0000 |
| S9 | Aspheric | 16.4065 | 0.3000 | 1.65 | 23.5 | −25.09 | 0.0000 |
| S10 | Aspheric | 8.0790 | 0.3638 | | | | 0.0000 |
| S11 | Aspheric | 8.5877 | 0.7000 | 1.68 | 19.2 | 15.92 | 0.0000 |
| S12 | Aspheric | 40.7391 | 0.7766 | | | | 0.0000 |
| S13 | Aspheric | 4.4887 | 0.3200 | 1.54 | 55.7 | −7.95 | 0.0000 |
| S14 | Aspheric | 2.1333 | 0.1303 | | | | −1.0000 |
| S15 | Spherical | Infinite | 0.2100 | 1.52 | 64.2 | | |
| S16 | Spherical | Infinite | 0.5567 | | | | |
| S17 | Spherical | Infinite | | | | | |

In Embodiment 9, both the object-side surface and image-side surface of any lens in the first lens E1 to the seventh lens E7 are aspheric surfaces. Table 18 shows higher-order coefficients A₄, A₆, A₈, A₁₀, A₁₂, A₁₄, A₁₆, A₁₈ and A₂₀ that can be used for each of the aspheric mirror surfaces S1-S14 in Embodiment 9.

TABLE 18

| Surface | | | | | |
|---|---|---|---|---|---|
| number | A4 | A6 | A8 | A10 | A12 |
| S1 | −5.2400E−04 | −7.9732E−04 | 5.1835E−04 | −2.3000E−04 | 6.3769E−05 |
| S2 | 2.3465E−02 | −1.6183E−02 | 1.0272E−02 | −4.2800E−03 | 1.1281E−03 |
| S3 | −5.3900E−04 | −1.5194E−02 | 1.3589E−02 | −6.2400E−03 | 1.6892E−03 |
| S4 | −1.1642E−02 | −5.0927E−03 | 5.1185E−03 | −3.0000E−03 | 1.1917E−03 |
| S5 | 2.3750E−02 | −1.3531E−02 | 1.4045E−02 | −1.2020E−02 | 6.4401E−03 |
| S6 | −1.2069E−02 | 8.4263E−03 | −7.0201E−03 | 4.3320E−03 | −1.7161E−03 |
| S7 | −3.4385E−02 | −2.0014E−03 | 1.0083E−02 | −1.3330E−02 | 9.5355E−03 |
| S8 | −2.5590E−02 | −4.1876E−03 | 1.2507E−02 | −1.8630E−02 | 1.5137E−02 |
| S9 | −2.6900E−02 | −6.9234E−02 | 1.9922E−01 | −2.8847E−01 | 2.4821E−01 |
| S10 | −6.5548E−02 | 3.3408E−02 | −2.3382E−02 | 1.9106E−02 | −1.2656E−02 |
| S11 | −3.8433E−02 | −8.3076E−03 | 1.3994E−02 | −7.8300E−03 | 1.4672E−03 |
| S12 | −2.7091E−02 | 1.3608E−02 | −1.4023E−02 | 6.7190E−03 | −1.6617E−03 |
| S13 | −1.9861E−01 | 1.3325E−01 | −7.3210E−02 | 2.8250E−02 | −7.4299E−03 |
| S14 | −2.1440E−01 | 1.2910E−01 | −5.5891E−02 | 1.6143E−02 | −3.1058E−03 |

| Surface | | | | |
|---|---|---|---|---|
| number | A14 | A16 | A18 | A20 |
| S1 | −1.1000E−05 | 1.0400E−06 | −5.1000E−08 | 8.8307E−10 |
| S2 | −1.9000E−04 | 1.9600E−05 | −1.2000E−06 | 2.9797E−08 |
| S3 | −2.8000E−04 | 2.7800E−05 | −1.5000E−06 | 3.6437E−08 |
| S4 | −3.0000E−04 | 4.4300E−05 | −3.4000E−06 | 1.0090E−07 |
| S5 | −2.0400E−03 | 3.7300E−04 | −3.7000E−05 | 1.4934E−06 |
| S6 | 4.3900E−04 | −7.0000E−05 | 6.2100E−06 | −2.3801E−07 |
| S7 | −4.0200E−03 | 1.0120E−03 | −1.4000E−04 | 8.2222E−06 |
| S8 | −7.3600E−03 | 2.1340E−03 | −3.4000E−04 | 2.2679E−05 |
| S9 | −1.3226E−01 | 4.2655E−02 | −7.6300E−03 | 5.7972E−04 |
| S10 | 5.2060E−03 | −1.2100E−03 | 1.4700E−04 | −7.2057E−06 |
| S11 | 2.3000E−04 | −1.3000E−04 | 1.8600E−05 | −8.9721E−07 |
| S12 | 1.7600E−04 | 4.1200E−06 | −2.3000E−06 | 1.3020E−07 |
| S13 | 1.2940E−03 | −1.4000E−04 | 8.8500E−06 | −2.3904E−07 |
| S14 | 3.9400E−04 | −3.2000E−05 | 1.4500E−06 | −2.9063E−08 |

FIG. 18A shows a longitudinal aberration curve of the optical imaging lens assembly according to Embodiment 9 to represent deviations of a convergence focal point after light with different wavelengths passes through the lens assembly. FIG. 18B shows an astigmatism curve of the optical imaging lens assembly according to Embodiment 9 to represent a tangential image surface curvature and a sagittal image surface curvature. FIG. 18C shows a distortion curve of the optical imaging lens according to Embodiment 9 to represent distortion values corresponding to different fields of view. FIG. 18D shows a lateral chromatic aberration curve of the optical imaging lens assembly according to Embodiment 9 to represent deviation of different image heights on the imaging surface after the light passes through the lens assembly. According to FIGS. 18A-18D, it can be seen that the optical imaging lens assembly provided in Embodiment 9 may achieve high imaging quality.

### Embodiment 10

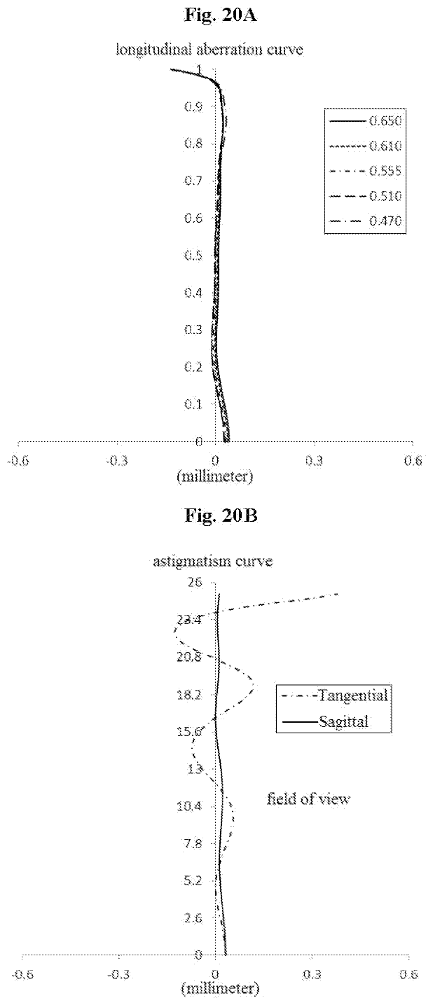

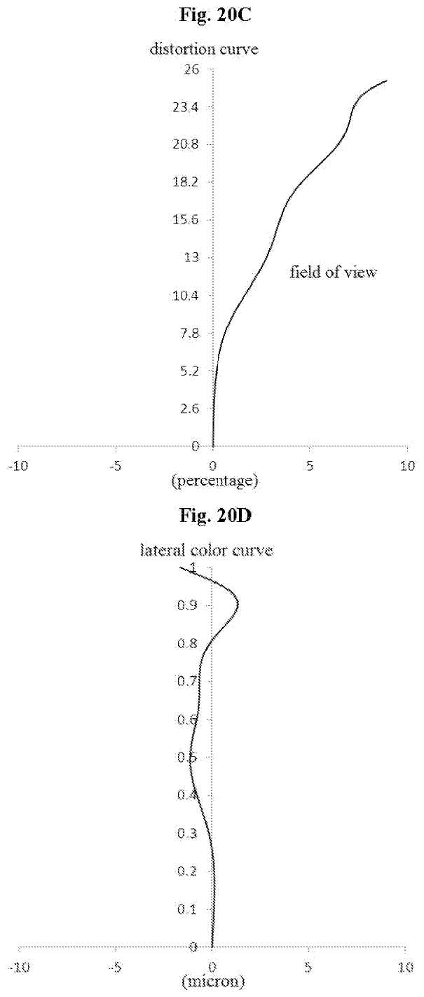

An optical imaging lens assembly according to Embodiment 10 of the disclosure will be described below with reference to FIGS. 19-20D. FIG. 19 is a structure diagram of an optical imaging lens assembly according to Embodiment 10 of the disclosure.

As shown in FIG. 19, the optical imaging lens assembly sequentially includes, from an object side to an image side along an optical axis, a diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, while an image-side surface S2 is a convex surface. The second lens E2 has a negative refractive power, an object-side surface S3 thereof is a convex surface, while an image-side surface S4 is a concave surface. The third lens E3 has a positive refractive power, an object-side surface S5 thereof is a convex surface, while an image-side surface S6 is a concave surface. The fourth lens E4 has a positive refractive power, an object-side surface S7 thereof is a convex surface, while an image-side surface S8 is a concave surface. The fifth lens E5 has a negative refractive power, an object-side surface S9 thereof is a convex surface, while an image-side surface S10 is a concave surface. The sixth lens E6 has a positive refractive power, an object-side surface S11 thereof is a convex surface, while an image-side surface S12 is a convex surface. The seventh lens E7 has a negative refractive power, an object-side surface S13 thereof is a convex surface, while an image-side surface S14 is a concave surface. The optical filter E8 has an object-side surface S15 and an image-side surface S16. Light from an object sequentially penetrates through each of the surfaces S1 to S16, and is finally imaged on the imaging surface S17.

In the embodiment, a total effective focal length f of the optical imaging lens is 7.26 mm. TTL is a distance from the object-side surface S1 of the first lens E1 to the imaging surface S17 on the optical axis, and TTL is 8.05 mm. ImgH is a half of a diagonal length of an effective pixel region on the imaging surface S17, and ImgH is 3.70 mm.

Table 19 shows a table of basic parameters for the optical imaging lens assembly of Embodiment 10, and units of the curvature radius, the thickness/distance and the focal length are all millimeter (mm).

TABLE 19

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | Infinite | | | | |
| STO | Spherical | Infinite | −1.4800 | | | | |
| S1 | Aspheric | 3.0524 | 1.8054 | 1.54 | 55.7 | 5.24 | 0.0000 |
| S2 | Aspheric | −28.1259 | 0.0300 | | | | 0.0000 |
| S3 | Aspheric | 4.9994 | 0.3300 | 1.68 | 19.2 | −9.10 | 0.0000 |
| S4 | Aspheric | 2.6866 | 0.1392 | | | | 0.0000 |
| S5 | Aspheric | 5.7897 | 0.8732 | 1.54 | 55.7 | 150.96 | 0.0000 |
| S6 | Aspheric | 5.9068 | 0.2621 | | | | 0.0000 |
| S7 | Aspheric | 3.0769 | 0.3500 | 1.54 | 55.7 | 40.27 | 0.0000 |
| S8 | Aspheric | 3.4451 | 0.7871 | | | | 0.0000 |
| S9 | Aspheric | 47.1345 | 0.3200 | 1.65 | 23.5 | −21.87 | 0.0000 |
| S10 | Aspheric | 10.8068 | 0.3339 | | | | 0.0000 |
| S11 | Aspheric | 11.0708 | 0.7000 | 1.68 | 19.2 | 15.90 | 0.0000 |
| S12 | Aspheric | −389.1610 | 0.7355 | | | | 0.0000 |
| S13 | Aspheric | 4.2276 | 0.3600 | 1.54 | 55.7 | −9.73 | 0.0000 |
| S14 | Aspheric | 2.2666 | 0.1926 | | | | −1.0000 |
| S15 | Spherical | Infinite | 0.2100 | 1.52 | 64.2 | | |
| S16 | Spherical | Infinite | 0.6190 | | | | |
| S17 | Spherical | Infinite | | | | | |

In Embodiment 10, both the object-side surface and image-side surface of any lens in the first lens E1 to the seventh lens E7 are aspheric surfaces. Table 20 shows higher-order coefficients A₄, A₆, A₈, A₁₀, A₁₂, A₁₄, A₁₆, A₁₈ and A₂₀ that can be used for each of the aspheric mirror surfaces S1-S14 in Embodiment 10.

TABLE 20

| Surface | | | | | |
|---|---|---|---|---|---|
| number | A4 | A6 | A8 | A10 | A12 |
| S1 | −8.6300E−04 | −3.2705E−04 | 1.0530E−04 | −3.2000E−05 | 6.4892E−07 |
| S2 | 2.3858E−02 | −1.3531E−02 | 7.5766E−03 | −3.1100E−03 | 8.2834E−04 |
| S3 | −5.1110E−03 | −9.5752E−03 | 9.0354E−03 | −4.2600E−03 | 1.1841E−03 |
| S4 | −1.1128E−02 | −4.0237E−03 | 3.6359E−03 | −2.4100E−03 | 1.0829E−03 |
| S5 | 3.4121E−02 | −1.6166E−02 | 1.2938E−02 | −1.0670E−02 | 5.8086E−03 |
| S6 | −8.4810E−03 | 4.3418E−03 | −4.0800E−03 | 2.8530E−03 | −1.1733E−03 |
| S7 | −3.4699E−02 | −3.6382E−03 | 1.0949E−02 | −1.4540E−02 | 1.1113E−02 |
| S8 | −2.0099E−02 | −1.4504E−02 | 3.1094E−02 | −4.2770E−02 | 3.5455E−02 |
| S9 | −1.9663E−02 | −6.6299E−02 | 1.7395E−01 | −2.5331E−01 | 2.2346E−01 |
| S10 | −4.3133E−02 | 4.8840E−03 | 5.6205E−03 | −3.9700E−03 | −3.9571E−05 |
| S11 | −2.5066E−02 | −2.1114E−02 | 2.8455E−02 | −1.9470E−02 | 7.1450E−03 |
| S12 | −2.0796E−02 | 7.9229E−03 | −8.9800E−03 | 3.4770E−03 | −3.5231E−04 |
| S13 | −1.4781E−01 | 7.3766E−02 | −3.3594E−02 | 1.1281E−02 | −2.7537E−03 |
| S14 | −1.5290E−01 | 7.1311E−02 | −2.5635E−02 | 6.3230E−03 | −1.0807E−03 |

| Surface | | | | |
|---|---|---|---|---|
| number | A14 | A16 | A18 | A20 |
| S1 | 1.5700E−06 | −4.2000E−07 | 4.4413E−08 | −1.7820E−09 |
| S2 | −1.4000E−04 | 1.4900E−05 | −8.9570E−07 | 2.3343E−08 |
| S3 | −2.0000E−04 | 2.0300E−05 | −1.1392E−06 | 2.7472E−08 |
| S4 | −2.9000E−04 | 4.1700E−05 | −3.0572E−06 | 8.5152E−08 |
| S5 | −1.8700E−03 | 3.4700E−04 | −3.4562E−05 | 1.4292E−06 |
| S6 | 2.8700E−04 | −4.1000E−05 | 3.1265E−06 | −9.9970E−08 |
| S7 | −5.0400E−03 | 1.3480E−03 | −1.9549E−04 | 1.1817E−05 |
| S8 | −1.7970E−02 | 5.4420E−03 | −9.0128E−04 | 6.2608E−05 |
| S9 | −1.2307E−01 | 4.1190E−02 | −7.6643E−03 | 6.0777E−04 |
| S10 | 8.1000E−04 | −2.9000E−04 | 4.2140E−05 | −2.2505E−06 |
| S11 | −1.4100E−03 | 1.4300E−04 | −5.9398E−06 | 1.4323E−08 |
| S12 | −1.5000E−04 | 5.1600E−05 | −6.1519E−06 | 2.6104E−07 |
| S13 | 4.8300E−04 | −5.8000E−05 | 4.1035E−06 | −1.3019E−07 |
| S14 | 1.3000E−04 | −1.1000E−05 | 5.2094E−07 | −1.1549E−08 |

FIG. 20A shows a longitudinal aberration curve of the optical imaging lens assembly according to Embodiment 10 to represent deviations of a convergence focal point after light with different wavelengths passes through the lens assembly. FIG. 20B shows an astigmatism curve of the optical imaging lens assembly according to Embodiment 10 to represent a tangential image surface curvature and a sagittal image surface curvature. FIG. 20C shows a distortion curve of the optical imaging lens according to Embodiment 10 to represent distortion values corresponding to different fields of view. FIG. 20D illustrates a lateral chromatic aberration curve of the optical imaging lens assembly according to Embodiment 10 to represent deviation of different image heights on the imaging surface after the light passes through the lens assembly. According to FIGS. 20A-20D, it can be seen that the optical imaging lens assembly provided in Embodiment 10 may achieve high imaging quality.

From the above, Embodiment 1 to Embodiment 10 meet a relationship shown in Table 21 respectively.

TABLE 21

| | embodiment | | | | | | | | | |
|---|---|---|---|---|---|---|---|---|---|---|
| Conditional expression/ | 1 | 2 | 3 | 4 | 5 | 6 | 7 | 8 | 9 | 10 |
| EPD/TAN(Semi-FOV)(mm) | 13.09 | 12.67 | 12.42 | 12.13 | 11.12 | 11.88 | 11.84 | 11.96 | 11.97 | 11.90 |
| f/EPD | 1.28 | 1.33 | 1.35 | 1.38 | 1.39 | 1.28 | 1.28 | 1.28 | 1.28 | 1.30 |
| TTL/EPD | 1.38 | 1.42 | 1.45 | 1.49 | 1.56 | 1.44 | 1.42 | 1.42 | 1.42 | 1.44 |
| (f2 + f7)/(f1 + f6) | −0.79 | −0.89 | −0.88 | −0.93 | −0.91 | −0.80 | −0.64 | −0.66 | −0.79 | −0.89 |
| (R3 + R4)/(R5 + R6) | 1.06 | 0.88 | 0.85 | 0.88 | 0.85 | 0.87 | 0.87 | 0.80 | 0.71 | 0.66 |
| (R7 × R8)/f4(mm) | 0.28 | 0.14 | 0.24 | 0.19 | 0.35 | 0.49 | 0.57 | 0.46 | 0.25 | 0.26 |
| f(mm) | 7.46 | 7.48 | 7.46 | 7.48 | 7.30 | 7.30 | 7.30 | 7.30 | 7.26 | 7.26 |
| (T34 + T45)/(T6 + T67) | 0.70 | 0.84 | 0.62 | 0.75 | 0.71 | 0.74 | 0.86 | 0.96 | 0.99 | 0.98 |
| CT1/TTL × 5 | 1.16 | 1.18 | 1.11 | 1.13 | 1.10 | 1.08 | 0.94 | 0.92 | 1.09 | 1.12 |
| SAG11/ImgH | 0.59 | 0.58 | 0.59 | 0.58 | 0.43 | 0.44 | 0.42 | 0.41 | 0.41 | 0.40 |
| SAG31/(SAG41 − SAG71) | 0.59 | 0.57 | 0.61 | 0.62 | 0.56 | 0.59 | 0.79 | 0.87 | 0.73 | 0.66 |
| f123/f | 1.30 | 1.18 | 1.25 | 1.24 | 1.32 | 1.30 | 1.25 | 1.17 | 1.09 | 1.11 |

The above is only the description about the preferred embodiments of the disclosure and adopted technical principles. It is understood by those skilled in the art that the scope of invention involved in the disclosure is not limited to the technical solutions formed by specifically combining the technical characteristics and should also cover other technical solutions formed by freely combining the technical characteristics or equivalent characteristics thereof without departing from the inventive concept, for example, technical solutions formed by mutually replacing the characteristics and (but not limited to) the technical characteristics with similar functions disclosed in the disclosure.

What is claimed is:

1. An optical imaging lens assembly, sequentially comprising,
from an object side to an image side along an optical axis:
a first lens with a positive refractive power,
a second lens with a negative refractive power,
a third lens with a refractive power,
a fourth lens with a refractive power,
a fifth lens with a refractive power,
a sixth lens with a positive refractive power, and
a seventh lens with a negative refractive power,
wherein EPD is an entrance pupil diameter of the optical imaging lens assembly, Semi-FOV is a half of a maximum field of view of the optical imaging lens assembly, and EPD and Semi-FOV satisfy: 11 mm<EPD/TAN(Semi-FOV)<20 mm.

2. The optical imaging lens assembly according to claim 1, wherein a total effective focal length f of the optical imaging lens assembly and EPD satisfy: f/EPD<1.4.

3. The optical imaging lens assembly according to claim 1, wherein TTL is a distance from an object-side surface of the first lens to an imaging surface of the optical imaging lens assembly on the optical axis, and TTL and EPD satisfy: 1.2<TTL/EPD<1.6.

4. The optical imaging lens assembly according to claim 1, wherein an effective focal length f1 of the first lens, an effective focal length f2 of the second lens, an effective focal length f6 of the sixth lens and an effective focal length f7 of the seventh lens satisfy:
−1<(f2+f7)/(f1+f6)<−0.6.

5. The optical imaging lens assembly according to claim 1, wherein a curvature radius R3 of an object-side surface of the second lens, a curvature radius R4 of an image-side surface of the second lens, a curvature radius R5 of an object-side surface of the third lens and a curvature radius R6 of an image-side surface of the third lens satisfy: 0.6<(R3+R4)/(R5+R6)<1.1.

6. The optical imaging lens assembly according to claim 1, wherein a curvature radius R7 of an object-side surface of the fourth lens, a curvature radius R8 of an image-side surface of the fourth lens and an effective focal length f4 of the fourth lens satisfy: 0.1 mm<(R7×R8)/f4<0.6 mm.

7. The optical imaging lens assembly according to claim 1, wherein a total effective focal length f of the optical imaging lens assembly satisfies: 7 mm<f<8 mm.

8. The optical imaging lens assembly according to claim 1, wherein a spacing distance T34 between the third lens and the fourth lens on the optical axis, a spacing distance T45 between the fourth lens and the fifth lens on the optical axis, a spacing distance T56 between the fifth lens and the sixth lens on the optical axis and a spacing distance T67 between the sixth lens and the seventh lens on the optical axis satisfy: 0.6<(T34+T45)/(T56+T67)<1.0.

9. The optical imaging lens assembly according to claim 1, wherein TTL is a distance from an object-side surface of the first lens to an imaging surface of the optical imaging lens assembly, and a center thickness CT1 of the first lens on the optical axis and TTL satisfy: 0.9<CT1/TTL×5<1.2.

10. The optical imaging lens assembly according to claim 1, wherein SAG11 is an on-axis distance from an intersection point of an object-side surface of the first lens and the optical axis to an effective radius vertex of the object-side surface of the first lens, ImgH is a half of a diagonal length of an effective pixel region on an imaging surface of the optical imaging lens assembly, and SAG11 and ImgH satisfy: 0.3<SAG11/ImgH<0.6.

11. The optical imaging lens assembly according to claim 1, wherein SAG31 is an on-axis distance from an intersection point of an object-side surface of the third lens and the optical axis to an effective radius vertex of the object-side surface of the third lens, SAG41 is an on-axis distance from an intersection point of an object-side surface of the fourth lens and the optical axis to an effective radius vertex of the object-side surface of the fourth lens, SAG71 is an on-axis distance from an intersection point of an object-side surface of the seventh lens and the optical axis to an effective radius vertex of the object-side surface of the seventh lens, and SAG31, SAG41 and SAG71 satisfy: 0.5<SAG31/(SAG41-SAG71)<0.9.

12. The optical imaging lens assembly according to claim 1, wherein a combined focal length f123 of the first lens, the second lens and the third lens and a total effective focal length f of the optical imaging lens assembly satisfy: 1.0<f123/f<1.4.

13. The optical imaging lens assembly according to claim 1, wherein an object-side surface of the first lens is a convex surface, an object-side surface of the sixth lens is a convex surface, and an image-side surface of the seventh lens is a concave surface.

14. An optical imaging lens assembly, sequentially comprising, from an object side to an image side along an optical axis:
a first lens with a positive refractive power,
a second lens with a negative refractive power,
a third lens with a refractive power,
a fourth lens with a refractive power,
a fifth lens with a refractive power,
a sixth lens with a positive refractive power, and
a seventh lens with a negative refractive power,
wherein a combined focal length f123 of the first lens, the second lens and the third lens and a total effective focal length f of the optical imaging lens assembly satisfy: 1.0<f123/f<1.4.

15. The optical imaging lens assembly according to claim 14, wherein EPD is an entrance pupil diameter of the optical imaging lens assembly, and f and EPD satisfy: f/EPD<1.4.

16. The optical imaging lens assembly according to claim 15, wherein Semi-FOV is a half of a maximum field of view of the optical imaging lens assembly, and EPD and Semi-FOV satisfy: 11 mm<EPD/TAN(Semi-FOV)<20 mm.

17. The optical imaging lens assembly according to claim 14, wherein TTL is a distance from an object-side surface of the first lens to an imaging surface of the optical imaging lens assembly on the optical axis, EPD is an entrance pupil diameter of the optical imaging lens assembly, and TTL and EPD satisfy: 1.2<TTL/EPD<1.6.

18. The optical imaging lens assembly according to claim 14, wherein an effective focal length f1 of the first lens, an effective focal length f2 of the second lens, an effective focal length f6 of the sixth lens and an effective focal length f7 of the seventh lens satisfy: −1<(f2+f7)/(f1+f6)<−0.6.

19. The optical imaging lens assembly according to claim 14, wherein a curvature radius R3 of an object-side surface of the second lens, a curvature radius R4 of an image-side surface of the second lens, a curvature radius R5 of an object-side surface of the third lens and a curvature radius R6 of an image-side surface of the third lens satisfy: 0.6<(R3+R4)/(R5+R6)<1.1.

20. The optical imaging lens assembly according to claim 14, wherein a curvature radius R7 of an object-side surface of the fourth lens, a curvature radius R8 of an image-side surface of the fourth lens and an effective focal length f4 of the fourth lens satisfy: 0.1 mm<(R7×R8)/f4<0.6 mm.

21. (canceled)

22. (canceled)

23. (canceled)

24. (canceled)

25. (canceled)

26. (canceled)
